(19) United States
(12) Patent Application Publication
(10) Pub. No.: US 2009/0022340 A1
(43) Pub. Date: Jan. 22, 2009

(54) Method of Acoustic Wave Generation

(75) Inventors: Igor A. Krichtafovitch, Kirkland, WA (US); Oharah L. Jacob, Seattle, WA (US); Vladislav A. Korolyov, Renton, WA (US); Nels E. Jewell-Larsen, Corvallis, OR (US); Sergey Karpov, Chestnut Hill, MA (US)

Correspondence Address: FULBRIGHT & JAWORSKI;MARKET SQUARE, 801 PENNSLYVANIA, N.W., WASHINGTON, DC, 200042604, US

(73) Assignee: Kronos Advanced Technologies, Inc., Belmont, MA (US)

(21) Appl. No.: 11/740,266

(22) Filed: Apr. 25, 2007

Related U.S. Application Data
(60) Provisional application No. 60/794,510, filed on Apr. 25, 2006.

(51) Int. Cl. H04B 11/00

(52) U.S. Cl. 381/165

(57) ABSTRACT

A method of converting an audio signal into vibratory modulation of a fluid includes converting a series of pulses representative of the audio signal into a plurality of signals having an intermediate peak-to-peak voltage; summing said signals having said intermediate voltage to provide a driver signal having a high peak-to-peak voltage; supplying said driver signal to an electrostatic fluid accelerator; and generating a corona discharge inducing said vibratory modulation of said fluid.

### RELATED APPLICATIONS

The present application claims the benefit of the earlier filing date of U.S. Provisional Patent Application No. 60/794,510 filed Apr. 25, 2006 in accordance with 35 U.S.C. § 119(e) and is related to the prior patents and patent applications of Igor Krichtafovitch et al. including, but not limited to, the following:

U.S. Pat. No. 6,504,308 entitled Electrostatic Fluid Accelerator;
U.S. Pat. No. 6,664,741, entitled Method Of And Apparatus For Electrostatic Fluid Acceleration Control Of A Fluid Flow;
U.S. Pat. No. 6,727,657 entitled Electrostatic Fluid Accelerator For And A Method Of Controlling Fluid Flow;
U.S. Pat. No. 6,888,314 entitled Electrostatic Fluid Accelerator;
U.S. Pat. No. 6,919,698 entitled; Electrostatic Fluid Accelerator For And Method Of Controlling A Fluid Flow;
U.S. Pat. No. 6,937,455 entitled Spark Management Method And Device;
U.S. Pat. No. 6,963,479 entitled Method Of And Apparatus For Electrostatic Fluid Acceleration Control Of A Fluid Flow;
U.S. Pat. No. 7,053,565 entitled Electrostatic Fluid Accelerator For And A Method Of Controlling Fluid Flow;
U.S. Pat. No. 7,122,070 entitled Method Of And Apparatus For Electrostatic Fluid Acceleration Control Of A Fluid Flow;
U.S. Pat. No. 7,150,780; entitled Electrostatic Air Cleaning device;
U.S. Pat. No. 7,157,704; entitled Corona discharge electrode and method of operating the same;
U.S. Patent Publication No. 20040217720 entitled Electrostatic Fluid Accelerator For And A Method Of Controlling Fluid Flow;
U.S. Patent Publication No. 20050151490 entitled Electrostatic Fluid Accelerator For And Method Of Controlling A Fluid Flow;
U.S. Patent Publication No. 20050200289 entitled Electrostatic Fluid Accelerator;
U.S. Patent Publication No. 20060055343 entitled Spark Management Method And Device; and
U.S. Patent Publication No. 20060226787 entitled Electrostatic Fluid Accelerator For And Method Of Controlling A Fluid Flow
all of which are incorporated herein in their entireties by reference.

### BACKGROUND OF THE INVENTION

1. Field of the Invention

The invention relates to a method of sound generation using ionic wind air movement modulation to produce audible, subaudible (e.g., infrasound or subsonic), and/or superaudible (e.g., ultrasonic) sound waves.

2. Description of the Related Art

A number of patents (see, e.g., U.S. Pat. Nos. 4,210,847 by Shannon, et al. and 4,231,766 by Spurgin) describe ion generation using an electrode (termed the “corona electrode”), accelerating and, thereby, accelerating charged particles (i.e., “ions”) toward another electrode (termed the “accelerating”, “accelerator” or “target” electrode), thereby imparting momentum to the ions in a direction toward the accelerating electrode. Collisions between the ions and an intervening fluid, such as surrounding air molecules, transfer the momentum of the ions to the fluid inducing a corresponding movement of the fluid to achieve an overall movement in a desired fluid flow direction (e.g., from corona electrode toward the accelerating electrode).

U.S. Pat. Nos. 4,789,801 of Lee; 5,667,564 of Weinberg; 6,176,977 of Taylor, et al.; and 4,643,745 of Sakakibara, et al. describe air movement devices that accelerate air using an electrostatic field. U.S. Pat. Nos. 4,812,711 and 5,077,500 of Torok et al. describe the use of Electrostatic Air Accelerators (EFA) having a combination of different electrodes placed at various locations with respect to each other and different voltage potentials. Air velocity achieved in these devices is very low and is not practical for commercial or industrial applications.

In addition to use of electrostatic fields to induce airflow, this effect has also been used to produce audio. U.S. Pat. No. 1,687,011 of Fleischmann entitled “Loud speaker”, 2,768,246 of Dr. Siegfried Klein entitled “Electrical Transducer” describes a speaker using corona discharge technology to create sound. This technology was incorporated in several products known as ion tweeters that were sold under names such as IonoPhone, Ionovac, and IonoFane. Later U.S. Pat. Nos. 1,695,075; 1,758,993; 2,768,246; 2,793,324; 2,830,233; 4,306,120; 4,464,544; 4,460,809 and 4,482,788 describe related systems using corona discharge to create sound including 360 degree sound dispersion.

Another use of high voltage for the direct generation of sound without use of an intermediate diaphragm (e.g., a fibrous semi-rigid cone attached to and mechanically driven by a voice coil) is described in U.S. Pat. No. 3,018,394 of Thomas Brown. Entitled “Electrokinetic Transducer”, the '394 patent describes use of an array of wires and plates which, when supplied with a high voltage potential, operates as a pump or fan. The disclosure further describes operation of the device as a loudspeaker to produce sound.

U.S. Pat. No. 4,789,801 of J. Lee entitled “Electrokinetic Transducing Methods And Apparatus And Systems Comprising Or Utilizing The Same” issued Dec. 6, 1988 describing an electrokinetic loudspeaker in which the widths and/or amplitudes of voltage pulses applied to arrays of electrodes may be varied in accordance with an audio signal to produce a desired sound output.

A number of related patent applications filed by J. Lee, C. Taylor and/or S. Lau and others on behalf of the Sharper Image Corporation include similar disclosures describing an the ionic wind generator wherein an “ . . . external audio input (e.g., from a stereo tuner) could be suitably coupled to [an] oscillator to acoustically modulate the kinetic airflow produced by [the] unit.” (See, e.g., U.S. Pat. Nos. 6,749,667, 6,713,026, 6,709,484, 6,350,417, 6,176,977, 6,163,098.) “The result would be an electrostatic loudspeaker, whose output air flow is audible to the human ear in accordance with the audio input signal”. The disclosure describes that [a] “high voltage generator unit preferably comprises a low voltage oscillator circuit of perhaps 20 KHz frequency, that outputs low voltage pulses to an electronic switch, e.g., a thyristor or the like. [A switch] switchably couples the low voltage pulses to the input winding of a step-up transformer. The secondary winding of the transformer is coupled to a high voltage multiplier circuit that outputs high voltage pulses”.

Gerald Shirley in “The Corona Wind Loudspeaker” suggests another configuration for modulating an output signal using a corona triode wherein a high voltage output signal is modulated via a modulating voltage at the grid located between the two electrodes. Unfortunately, the volume level produced by the triode configuration is insufficient for most uses.

The current invention describes further improvements and enhancements to electrokinetic transducer devices and methods based on modulation of a corona discharge to produce audible and/or inaudible vibratory motion of a fluid such as air.

### SUMMARY OF THE INVENTION

The invention is broadly directed to a method of converting an audio signal into vibratory modulation of a fluid. For purposes of reference, embodiments may be characterized as loudspeakers although other varied applications and uses of transducers in accordance with the methods described herein will be described. Such devices may include a HVPS and an electrostatic fluid accelerator (EFA). The HVPS may include (i) a control circuit responsive to the audio signal; (ii) a power input stage responsive to the control circuit for selectively supplying input power; and (iii) a power converter stage configured to convert the input power to a high voltage, the power converter stage having an internal capacitive loading substantially less than an external capacitive loading. The EFA may be connected to receive the high voltage for generating the vibratory modulation of the fluid, the electrostatic fluid accelerator and include (i) an array of corona discharge electrodes; and (ii) an array of accelerator electrodes.

According to one aspect of the invention, a capacitance formed by the corona and accelerator electrodes constitutes substantially all of the external capacitive loading to which the power converter stage is subjected.

According to one aspect of the invention, the power converter stage may include a DC portion including a capacitive filtering stage for supplying a DC voltage and an A.C. portion having a resistive output stage for supplying an A.C. voltage, The DC and A.C. portions may be connected to combine the DC and A.C. voltages to form the high voltage with a total capacitance value of the DC portion being substantially greater and total capacitance value of the A.C. portions being substantially less a value of the external capacitive loading. For example, the DC portion may have a total capacitance value that is at least twice or ten times that of the external load while the A.C. portion may have a total capacitance value that is not greater than one half or one-tenth that of the external load. The power converter stage (e.g., either or both the A.C. and/or DC portions) may further include a device (e.g., circuit) for rapidly discharging electrical power stored in an external capacitance of the EFA array.

According to another aspect of the invention, the power converter stage may include a low-frequency portion for supplying and/or operating to supply a low-frequency high voltage and a high-frequency portion for supplying and/or operating to supply mid- and high-frequency voltages, the low-frequency and high-frequency portions connected to combine a sum of the voltages.

According to another aspect of the invention, a device (e.g., circuit) may be included for rapidly discharging electrical power stored in an external capacitance of the EFA array.

According to another aspect of the invention, a value of the internal capacitive loading (e.g., that of the A.C. and/or DC portions of the power converter stage, individually and/or collectively) is no greater than one-hundredth of a value of the external capacitive loading (e.g., a capacitance formed by the corona and accelerator electrodes.

According to another aspect of the invention, the control circuit is responsive to the audio signal for adjusting duration of each of a series of pulses constituting the input power. The series of pulses may occur at some regular interval and/or frequency of, for example, at least 16 kHz and, more preferably, greater than 40 kHz. Each of the pulses of the series of pulses may have substantially equal amplitudes.

According to another aspect of the invention, the control circuit may be responsive to the audio signal for adjusting an amplitude of each of a series of pulses constituting the input power. Each of the pulses of the series of pulses may have substantially equal widths, i.e., periods or time durations.

According to another aspect of the invention, various types of modulations known in the art may be used to impart audio information including the aforementioned pulse modulation techniques (including Pulse-code modulation (PCM), Pulse-width modulation (PWM), Pulse-amplitude modulation (PAM), Pulse-position modulation (PPM), Pulse-density modulation (PDM), and Sigma-delta modulation (ΣΔ)) and pulse-like frequency modulation that permits control of the amount of energy transferred to the output and used for sound generation.

According to another aspect of the invention, the power converter stage may include or contain a plurality of switching elements connected in a bridge circuit configuration, e.g., a half bridge or a full bridge circuit configuration.

According to another aspect of the invention, the power input stage may include a DC to AC converter.

According to another aspect of the invention, the power converter stage may include a transformer and a plurality of rectifiers. The transformer may have a primary winding connected to receive the input power and a plurality of secondary windings supplying, e.g., a high voltage on the order of several thousand volts, for example. The plurality of rectifiers may be connected to respective ones of the secondary windings, outputs from the rectifiers connected in series to provide the high voltage.

According to another aspect of the invention, the power converter stage may include one or more transformers, each having a primary winding connected to receive the input power, each of the transformers has one or more secondary windings. A plurality of rectifiers may be connected to respective ones of the secondary windings, outputs from the rectifiers connected in series to provide the high voltage.

According to another aspect of the invention, a time constant of the power converter stage in combination with the electrostatic fluid accelerator is less than 1 msec. and, more preferably, less than 20 μsec.

According to another aspect of the invention, the audio signal is selected from the group of signal types consisting of (i) analog, (ii) Pulse Code Modulation, (iii) Differential Pulse Code Modulation, (iv) Adaptive Differential Pulse Code Modulation, (v) μ-law, and (vi) MPEG.

According to another aspect of the invention, a method of converting an audio signal into vibratory modulation of a fluid comprising the steps of converting a series of pulses representative of the audio signal into a plurality of signals having an intermediate peak-to-peak voltage; summing the signals having the intermediate voltage to provide a driver signal having a high peak-to-peak voltage; supplying the driver signal to an electrostatic fluid accelerator; and generating a corona discharge inducing the vibratory modulation of the fluid.

According to another aspect of the invention, the step of converting may include modulating a width and/or amplitude of the pulses in response to an amplitude characteristic of the audio signal.

According to another aspect of the invention, the step of converting includes generating a regular series of the pulses at a frequency of least 16 kHz and, more preferably, at least 40 kHz.

According to another aspect of the invention, a maximum magnitude or value of the high-frequency voltage is not greater than the difference between a magnitude of the low-frequency voltage and that of the corona onset voltage of the EFA array.

According to another aspect of the invention, wherein the difference between low-frequency voltage magnitude (e.g., a bias voltage) and the corona onset voltage of the EFA array is maintained at a level close to the high-frequency voltage maximum magnitude (e.g., within ten-percent and, more preferably, within one-percent) during each selected time period.

According to another aspect of the invention, a low-frequency high voltage magnitude (e.g., a DC bias) is preemptively responsive to a high-frequency nigh voltage magnitude (e.g., a voltage level responsive to and/or representative of the audio signal) and changes its value ahead of time (i.e., in advance of high-frequency voltage.) A target value of the low-frequency high voltage may be selected so that, when added to the high-frequency high voltage, the composite signal so formed has a minimum peak value that is approximately but at least a corona onset or discharge value of the EFA array. That is,

$${V}_{B} = {V}_{0} + \frac{{V}_{{AC}_{PP}}}{2}$$

where

V_{B} is a low frequency of DC bias voltage level;

V₀ is a corona onset voltage level; and

V_{ACPP} is the peak-to-peak magnitude of a high frequency voltage component.

A response time may be selected so that that a transition time of V_{B} provides for attainment of a desired bias voltage no later than a first occurrence of the corresponding maximum peak values of the high frequency voltage while providing a transition time and frequency that is not audible (e.g., below 20 Hz).

According to another aspect of the invention, a low-frequency component voltage magnitude (e.g., a DC bias voltage level) follows a high-frequency voltage magnitude or level, the low-frequency component changing its value ahead of time, i.e. in advance of the high-frequency voltage. According to a feature, adjustment of the low-frequency voltage may be accomplished by scanning a stored or recorded acoustic signal (e.g., scanning or looking ahead) to determine a maximum high-frequency input acoustic signal magnitude (e.g., some upcoming maximum peak-to-peak signal value). The amount of “look ahead” may be selected so that adjustment of the low-frequency voltage magnitude (e.g., DC bias voltage) for each time period may be implemented by relatively slow changes to the level of the low-frequency voltage such that no or little audible components or artifacts are generated. The magnitude of the low-frequency high voltage is maintained so as a difference between the low-frequency high voltage and corona onset voltage is at or only slightly greater than a high-frequency voltage magnitude. That is, according to a feature of the invention, a bias voltage may be varied at a subaudible rate so as to maintain an instantaneous minimum peak voltage level of a signal applied to an EFA to be equal to or slightly greater than a corona onset voltage of the EFA. According to another aspect of the invention, wherein high-frequency portion includes step-up transformer; the low-frequency portion includes power inverter and several decoupled rectifiers with outputs connected in series and/or the low-frequency and high-frequency portions outputs are both connected with one terminal to the common point preferably close to a ground potential. The difference between the common point potential and the ground potential should be no more or around the maximum rectified voltage of the main. That is if main caries 110 V sinusoidal voltage, the common point should differ from the ground at about 110*sq/root (2)=155 V. If main carries 220 V, the difference suppose to be around 310 V and so forth.

According to another aspect of the invention, a sum of the outputs from the power converter stage having a higher positive potential (e.g., high positive voltage relative to a voltage supplied to the accelerator electrodes) is connected to one or more of the corona discharge electrodes.

According to another aspect of the invention, wherein the sound transducer (including, e.g., the EFA array) is mounted in an enclosure (e.g., a box) or onto/against a solid material (e.g., a wall) adjacent an air intake side or portion of the EFA array so as to restrict an airflow through the EFA but allow/permit air modulation and sound generation.

According to another aspect of the invention, wherein the sound transducer (including, e.g., the EFA array) is placed and/or mounted in an enclosure that is covered, at least on one side, with sound permeable/penetrable media that allows (i.e., does not substantially attenuate) sound penetration but restricts airflow. This media may be, for example, be made in the same manner as a fabric cover of the conventional loudspeakers.

According to another aspect of the invention, an enclosure may contain or include one or more ozone scrubbing materials, e.g., an “ozone filter” such as activated coal, activated charcoal, carbon, etc. The ozone filter may be placed or position at an upwind side (e.g., intake) of the electrode array or at a downwind (e.g., outlet or exhaust portion) of the array. A sound penetrable media (e.g., acoustically transparent) may include an ozone scrubbing material.

According to another aspect of the invention, a sealed enclosure may be filled with dust and chemicals free media. The media may be devoid of or otherwise contain some small or minimum constituent amount of oxygen and may further include some significant proportion and/or amount of nitrogen as a constituent. The media may further contain one of more of the following: gaseous N₂, liquid N₂, H₂, and/or SF₆. The media may further include and/or be constituted (made) of a high dielectric strength media, a pressurized (e.g., greater than an ambient or atmospheric pressure) gas, and/or contains heavy particles or aerosol suspended in the media.

According to another aspect of the invention, the control system may convert an input audio signal into a frequency range that being coupled with the media acoustic properties generates undistorted output sound. For example, the control system may include a transfer function (e.g., frequency response) that compensates for performance characteristics of other system components so that the resultant audible signal has a desired characteristic, e.g., system fidelity is high so that overall signal distortion is minimized and a substantially flat frequency response over some range (e.g., 20 Hz to 20 kHz) is achieved.

According to another aspect of the invention, a chamber material is used as a resonant body. A chamber wall may act as both a barrier to contain a fluid (e.g., a container for the fluid) and as the collector electrode. In this case at least a portion of the chamber should be made of either a conductive or semi-conductive (i.e. with some conductivity and not good as a pure insulator) material.

According to another aspect of the invention, a solid (e.g., rigid or inflexible) or flexible conductive media may be connected to the power supply and located in the proximity of the corona electrodes to act and function as an accelerator electrode.

According to another aspect of the invention, a chamber geometry may be selected and used to alter sound directionality, e.g., to provide a desired directivity and patterning to the emitted audio. For example, a substantially flat EFA may be provide to, in some cases, enhance sound quality and intensity for the listeners who are placed directly in front of the EFA outlet. Conversely, curving the chamber enhances off-axis sound distribution so that a wider or “pointed, e.g. focused” distribution of listeners may be served.

According to another aspect of the invention, including a film having deposited thereon or therein (e.g., impregnated, plated, coated, etc.) a conductive media in the volume or on a surface.

According to another aspect of the invention, a conductive media connected to the power supply and located in the proximity of the corona electrodes acting as an accelerator electrode, the conductive media formed as a mesh or web of conductive material mixed with less conductive material to ensure more even electric potential distribution.

According to another aspect of the invention, a semiconductive barrier may be included or used as the accelerator electrode, the semiconductor barrier made of a clear plastic or film.

According to another aspect of the invention, one of the electrodes (either corona electrode or accelerator electrode) is connected to a potential (e.g., ground) that is safe for the listeners if inadvertently contacted. For example, the safe potential may be sufficiently close to a ground potential to avoid presenting an electrical shock hazard. Preferably, the electrode connected to the safe potential is positioned closest to the listener while another electrodes (e.g., have applied to it some high, presumably dangerous, voltage) are located out of reach of the listeners.

According to another aspect of the invention, the EFA includes multiple electrodes (either corona electrodes or accelerator electrodes or both), at least some of these multiple electrodes being powered with separate power sources. The separately or individually powered electrodes or pairs of electrodes may be configured to generate or “create” their own sound pattern in order to generate a resultant, composite or common sound with some desirable directionality and/or desirable sound effect, such as stereo sound, surround sound, sound coming from a single point or a single line acoustic source and so forth. Power supplied to the individually powered electrodes or to the electrodes pairs may be provided or delivered with individual time delays to provide a desired effect for a particular configuration and listening environment (e.g., room geometry, etc.). The power supplied to the individually powered electrodes or to the electrode pairs may be supplied or delivered with some dynamically changing time delay including, for example, some time delay relationship between pairs of electrodes that is responsive to a desired directivity control signal. Further, power to the individually powered electrodes or to the electrodes pairs may be supplied or delivered with different intensities, e.g., voltage magnitudes or levels appropriate to provide a desired effect.

According to another aspect of the invention, corona electrodes may be configured as wire-like electrodes substantially parallel to the accelerator electrodes. Alternatively or in addition, accelerator electrodes may be rod-like (e.g., elongated cylinders), plate-like (e.g., sheet), surface-like, while corona discharge electrodes may be needle-like (elongated conical sections), wire-like and/or razor-like electrodes. Wherein the accelerator electrodes are plate-like, or rode-like, or surface-like electrodes they may be positioned in a plane that is substantially parallel to the plane where corona wire-like electrodes' ion emitting edges are located. Needle-like electrodes may be positioned substantially parallel to tube-like accelerator electrodes, the needle-like corona electrodes positioned inside of the tube-like accelerator electrodes. Alternatively, needle-like corona electrodes may be positioned substantially orthogonal or parallel to the plate-like accelerator electrodes. Likewise, razor-like corona electrodes may be positioned substantially parallel to the accelerator plate-like electrodes.

According to another aspect of the invention, and EFA may contain at least three sets of the electrodes, two of these sets of the electrodes being substantially the same (i.e. either two sets of the corona electrodes and one set of the accelerator electrodes, or two sets of the accelerator electrodes and one set of the corona electrodes), wherein two alike electrodes are located on the opposite sides of the second set of the electrodes (for example, two sets of the corona electrodes are located on the left and on the right sides of the accelerator electrode). The “alike” electrodes may be powered individually and/or such that the phase of the voltage delivered to one set of the alike electrodes is shifted in time with regard to the phase of the voltage delivered to the second set of the alike electrode. According to another feature, the “alike” electrodes may be powered individually with substantially same voltage magnitude and/or with a dynamically controlled voltage magnitude.

According to another aspect of the invention, the control system measures the sound intensity on one side of the sound transducer and changes time delay so the sound on the measured side is of some minimum intensity.

According to another aspect of the invention, where in the absence of acoustic signal, an electric potential difference maintained between both alike electrodes voltage with respect to the non-alike electrode is the same. Then, during a first time interval wherein an input acoustic signal increases in intensity, the electric potential difference between the first alike electrode with respect to the non-like electrode also increases while electric potential difference of the second alike electrode decreases providing the desired air velocity and air pressure. During a second time interval when the input acoustic signal is detected to be decreasing, the operation of the first and second alike electrodes is reversed: an electric potential difference of the first alike electrode decreases while electric potential difference of the second alike electrode increases.

According to another aspect of the invention, a method of converting an audio signal into vibratory modulation of a fluid comprises the steps of determining fluid (e.g., air) composition and/or condition (temp, pressure, humidity, etc . . . ), calculating an expected or predicted electrical breakdown voltage in the air, scanning a soundtrack or waveform to determine a “danger value” for all points or a subset of outlier points, calculating and modifying some parts of the waveform having some maximum possible voltage so that an resultant potential supplied to a load device (e.g., an EFA) is maintained at or limited to some safe level according to the current fluid composition and/or condition.

According to another aspect of the invention, a fluid composition and/or condition is constantly, continually and/or periodically monitored and, in response, a voltage adjustment is also constantly, continually and/or periodically adjusted, respectively, as necessary.

According to another aspect of the invention, ultrasonic acoustic pressure waves may be generated in a fluid, these acoustic pressure waves being directed or focused onto a desired surface in order to clean it and/or eliminate some impurity from the surface.

According to another aspect of the invention, a “target surface” contains a conductive media and is connected to the power supply thus functioning as the accelerator electrode.

According to another aspect of the invention, a device may produce or a method include a step of producing short powerful bursts of acoustic energy directed to a target, e.g., a certain object or an attacker, and used as an acoustic weapon or defensive tool. Such an “acoustic weapon” or “defensive tool” may incorporate and/or use a phase array technique (geometrical or electrical) to create a single point, line, or multiple of points or lines with high intensity acoustic energy within a three-dimensional (i.e., “3D”) space.

According to another aspect of the invention, the EFA may be contained and/or mounted within a chamber that is made of and/or contains a fluid that is less dense than the environmental fluid surrounding it, allowing the EFA acoustic actuator to become buoyant in the environment and float. The environment fluid may be a liquid as well as air or any other fluid.

According to another aspect of the invention, the EFA may be contained and/or mounted in a sealed enclosure that is filled with a fluid that is less dense than the environmental fluid surrounding it, allowing the EFA acoustic “actuator” to become buoyant in the environment and float or became airborne.

According to another aspect of the invention, a sensor may be included to measure output (corona) current and/or voltage between the electrodes, sense or detect a spark or pre-spark condition and promptly decreases high voltage to a safe level to avoid spark generation and/or extinguish any spark.

According to another aspect of the invention, an EFA contains two or more sets of electrodes, each of set including one or more corona electrodes and one or more accelerator electrodes, these sets of electrodes located in series or “tandem” in such a manner that fluid pressure created by one set of the electrodes is increased by the neighboring or “next” set of the electrodes. A high voltage signal supplied and/or applied to the sets of the electrodes may differ in time by the time fluid sound travels the distance separating those electrodes, e.g., the high voltage signal is phased to take into account fluid movement time between electrodes so that modulation energy is added with the proper phase.

According to another aspect of the invention, a space such as a room, may have walls and/or a ceiling that are covered with light-weight sound transducers as previously described. Some or all of the sound transducers may be individually powered to provide optimum sound clarity to an audience, i.e., collection of individuals. Sensor may be used to detect and/or determine environmental, geometry, audience and/or other conditions and, in response, control and adjust the sound output to optimize delivery and reception of the sound to those present.

According to another aspect of the invention, a sound transducer or “corona loudspeaker” may include some number (e.g., a plurality) of wire-like corona electrodes and accelerator electrodes, both corona electrodes and accelerator electrodes being spaced and separated by some distance that is greater than a thickness of the accelerator electrodes, all the electrodes ends being secured in expandable arrangement that is collapsible or able to be telescoped.

According to another aspect of the invention, a sound transducer wherein a corona electrode to collector electrode spacing is on the order of several (e.g., five) millimeters or less (e.g., one millimeter or less) and a high tip curvature cantilever or needle like corona electrode is used. Such a configuration may include many (e.g., a large plurality of) such “small scale” transducers that are arranged in a 1, 2, or 3 dimensional array, each transducer independently controlled (e.g., turned on and off) such that the overall array of transducers works and functions as a digital speaker.

According to another aspect of the invention, an EFA may be placed into or mounted with an enclosure that is covered at least on one side with sound penetrable (e.g., acoustically transparent) media that allows sound penetration but restricts airflow. A getter material may be exposed to a fluid medium contained within a closed chamber formed the enclosure such that the getter material is able to chemically or otherwise remove a specific gas from the fluid medium of the chamber.

According to another aspect of the invention, where a temperature of the corona electrode is modulated in order to modulate discharge current and thus create an acoustic signal.

According to another aspect of the invention, wherein a temperature of the corona electrode is altered in order to increase or decrease the DC discharge current and thus change the acoustic wave amplification factor.

According to another aspect of the invention, a periodic voltage is added to the acoustic voltage waveform, the periodic voltage being substantially equal in amplitude but opposite to the output voltage ripple of the HV power supply seen at the corona electrode.

According to another aspect of the invention, a sound transducer for converting an audio signal into vibratory modulation of a fluid includes a high voltage power supply and an Electrostatic Fluid Accelerator (EFA) array. The high voltage power supply includes (i) a control circuit responsive to the audio signal; (ii) a power input stage responsive to the control circuit for selectively supplying input power; and (iii) a power converter stage configured to convert the input power to a high voltage output, the power converter stage having an internal capacitive loading substantially less than an external capacitive loading. The EFA array is connected to receive the high voltage for generating the vibratory modulation of the fluid, the electrostatic fluid accelerator and includes (i) an array of corona discharge electrodes, and (ii) an array of collector electrodes. According one feature of the invention, a capacitance formed by the corona and collector electrodes constituting substantially all of the external capacitive loading to which the power converter stage is subjected.

According to another aspect of the invention the high voltage power supply includes a power converter stage having (a) a low-frequency portion connected to supply a low-frequency high voltage; and (b) a high-frequency portion connect to supply a high-frequency voltage, the low-frequency and high-frequency portions connected to combine the low-frequency and high-frequency voltages to form the high voltage output.

According to another aspect of the invention, the power converter stage may have an internal capacitive loading substantially less than an external capacitive loading. Further, a capacitance formed by the corona and collector electrodes may constitute substantially all of the external capacitive loading to which the power converter stage is subjected.

According to another aspect of the invention, a difference between a voltage level of (i) the low-frequency voltage and (ii) a corona onset voltage of the EFA array is maintained at a level close to a voltage level of the high-frequency voltage during each of a plurality of time periods whereby a maximum acceptable distortion of an audio output is not exceeded.

According to another aspect of the invention, the high voltage power supply is responsive to a maximum peak level of the audio signal for dynamically adjusting a voltage level of the low-frequency high voltage.

According to another aspect of the invention, wherein the audio signal comprises a plurality of contiguous segments, the high voltage power supply may be responsive to a maximum peak level of the audio signal occurring within each of the segments for dynamically adjusting a bias voltage level of the low-frequency high voltage such that a minimum voltage level of the high voltage output is not less than a corona onset voltage of the EFA array for each of the segments.

According to another aspect of the invention the low-frequency and high-frequency high voltages are both connected to a common terminal maintained at a potential close to or at a ground potential.

According to another aspect of the invention, the low-frequency and high-frequency high voltages are both connected to a common terminal maintained at a ground potential.

According to another aspect of the invention, a terminal of the high voltage power supply having a higher positive potential is connected to the array of corona discharge electrodes of the EFA.

According to another aspect of the invention, the sound transducer may further include an enclosure housing the EFA and a sound penetrable media attached to the enclosure, the sound penetrable media being substantially acoustically transparent but restrictive of an airflow therethrough.

According to another aspect of the invention, the sound transducer may further include an enclosure forming a sealed chamber housing the EFA and providing containment for a fluid within the enclosure.

According to another aspect of the invention, the sound transducer may further include an enclosure forming a sealed chamber housing the EFA, the collector electrodes comprising a wall of the chamber, the wall of the chamber comprising a material that is at least semiconductive and connected to receive the high voltage output from the power converter stage.

According to another aspect of the invention, the array of collector electrodes may comprise a conductive media formed as a sheet-like structure.

According to another aspect of the invention, the array of collector electrodes may comprise a film including a conductive media rendering the film at least semiconductive.

According to another aspect of the invention, the array of collector electrodes may comprise an optically transparent material.

According to another aspect of the invention, the sound transducer may include at least three sets of the electrodes, two of the three sets comprising one type of electrode selected from a set consisting of the corona discharge electrodes and the collector electrodes, a remaining set of the three sets comprising the other type of the electrodes selected from the set, electrodes of the two located on opposite sides of electrodes of the remaining set.

According to another aspect of the invention, each of the corona discharge electrodes may be positioned between pairs of the of the collector electrodes with collector electrodes of the pairs of collector electrodes being separately controlled.

According to another aspect of the invention, each of the collector electrodes may be positioned between pairs of the of the corona discharge electrodes, corona discharge electrodes of the pairs of corona discharge electrodes being separately controlled.

According to another aspect of the invention, a sound transducer for converting an audio signal into vibratory modulation of a fluid includes a high voltage power supply and an electrostatic fluid accelerator (EFA). The high voltage power supply may include (i) a transformerless low-frequency portion responsive to a low-frequency component of the audio signal for supplying a low-frequency high voltage; (ii) a high-frequency portion including a step-up transformer, the high-frequency portion responsive to a high-frequency component of the audio signal for supplying a high-frequency voltage; and (iii) an output combining the low-frequency and high-frequency voltages to form a high voltage output. The EFA may connected to receive the high voltage output for generating the vibratory modulation of the fluid and include an EFA array having (i) an array of corona discharge electrodes, and (ii) an array of collector electrodes.

According to another aspect of the invention, a method of converting an audio signal into vibratory modulation of a fluid comprising the steps of (i) converting a series of pulses representative of the audio signal into a plurality of signals having an intermediate peak-to-peak voltage; (ii) summing the signals having the intermediate voltage to provide a driver signal having a high peak-to-peak voltage; (iii) supplying the driver signal to an electrostatic fluid accelerator; and (iv) generating a corona discharge inducing the vibratory modulation of the fluid.

According to another aspect of the invention, the step of converting includes modulating a width of the pulses in response to an amplitude characteristic of the audio signal.

According to another aspect of the invention, the step of converting includes modulating an amplitude of the pulses in response to an amplitude characteristic of the audio signal.

According to another aspect of the invention, the step of converting includes generating a regular series of the pulses at a frequency of least 16 kHz.

According to another aspect of the invention, the step of converting includes generating a regular series of the pulses at a frequency of least 40 kHz.

According to another aspect of the invention, a method of converting an audio signal into vibratory modulation of a fluid comprising the steps of: (i) partitioning the audio signal into low-frequency and high-frequency constituent signals; (ii) multiplying an input voltage to provide a first high voltage; (iii) modulating the first high voltage with the low-frequency constituent signal to provide a low-frequency high voltage; (iv) transforming the input voltage to provide a second high voltage; (v) modulating the second high voltage with the high-frequency constituent signal to provide a high-frequency high voltage; (vi) combining the low-frequency and the high-frequency high voltage to provide a high voltage output; (vii) supplying the high voltage output to an electrostatic fluid accelerator (EFA); and (viii) modulating a fluid with the electrostatic fluid accelerator.

According to another aspect of the invention, a step of rapidly discharging electrical power stored in an external capacitance of the EFA array may be provided.

According to another aspect of the invention, a further step may include maintaining a difference between a voltage level of (i) the low-frequency voltage and (ii) a corona onset voltage of the EFA array close to a voltage level of the high-frequency voltage during each of a plurality of time periods whereby a maximum acceptable distortion of an audio output is not exceeded.

According to another aspect of the invention, a further step may include dynamically adjusting a voltage level of the low-frequency high voltage in response to a maximum peak level of the audio signal.

According to another aspect of the invention, wherein the comprises a plurality of contiguous segments, the method may further include a step of dynamically adjusting, for each of the segments, a bias voltage level of the low-frequency high voltage in response to a maximum peak level of the audio signal occurring within each of the segments such that a minimum voltage level of the high voltage output is not less than a corona onset voltage of the EFA array. Additional objects, advantages and novel features of the invention will be set forth in part in the description which follows, and in part will become apparent to those skilled in the art upon examination of the following and the accompanying drawings or may be learned by practice of the invention. The objects and advantages of the invention may be realized and attained by means of the instrumentalities and combinations particularly pointed out in the appended claims.

### BRIEF DESCRIPTION OF THE DRAWINGS

The drawing figures depict preferred embodiments of the present invention by way of example, not by way of limitations. In the figures, like reference numerals refer to the same or similar elements.

FIG. 1 is a schematic diagram of a voltage doubler circuit according to the prior art;

FIG. 2 is a schematic diagram of an “inertialess” HVPS (HVPS)

FIG. 3 is a waveform diagram of pulse-width modulation (PWM) of an audio signal;

FIG. 4 is a schematic diagram of another inertialess HVPS configuration;

FIG. 5 is a schematic diagram of another inertialess HVPS configuration;

FIG. 6 a block diagram of the stereo HVPS and EFA loudspeaker;

FIG. 7 is a waveform diagram depicting a voltage across the EFA array as sound intensity is continuously changing;

FIG. 8 is a schematic diagram of an HVPS including a step-up power transformer;

FIG. 9 is a schematic diagram depicting an EFA enclosed in a sealed enclosure including an ozone filter;

FIG. 10 is a schematic diagram of an EFA placed into and/or mounted within a sealed enclosure that is filled with a fluid;

FIG. 11 is a schematic diagram of another example of an EFA placed into a sealed enclosure that is filled with a fluid;

FIG. 12 is a schematic diagram of a phased array of EFA loudspeakers;

FIGS. 13-16 show several implementations of phased array EFAs;

FIG. 17 is a schematic diagram of a uni-directional EFA loudspeaker;

FIG. 18 is a schematic diagram of a mini-loudspeaker;

FIG. 19 is a schematic diagram depicting a simplified arrangement of corona wires and accelerator electrodes;

FIG. 20 is a waveform diagram depicting a voltage generated by a HVPS and the resultant actual or “real voltage” present across an EFA at high frequencies;

FIG. 21 is a schematic diagram of two double wire-accelerator electrode combinations;

FIG. 22 is a schematic diagram of two configurations of ultrasound surface cleaning devices using EFA loudspeaker technology;

FIG. 23 is a schematic diagram of a loudspeaker using an EFA having curved or “globe-shaped” electrodes; and

FIG. 24 is a schematic diagram of a “folded” EFA loudspeaker.

### DETAILED DESCRIPTION OF THE PREFERRED EMBODIMENTS

For ease of presentation, the following description includes various captions and headings for purposes of reference. All such captions, headings, and division of material are not to be construed as limiting of the invention, the embodiments described therein, or otherwise. Likewise, the titles and/or descriptions of each section or division are for purposes of ease of reference and are not considered to be substantive limitations.

The invention is broadly directed to a sound transducer device for converting an audio signal into vibratory modulation of a fluid. For example, where the fluid is air, the device may function as a loudspeaker to generate audible acoustic or sound waves. The device may include a HVPS and an electrostatic fluid accelerator (EFA). The HVPS may include (i) a control circuit responsive to the audio signal; (ii) a power input stage responsive to the control circuit for selectively supplying input power; and (iii) a power converter stage configured to convert the input power to a high voltage, the power converter stage preferably having an internal capacitive loading substantially less than an external capacitive loading. The EFA may be connected to receive the high voltage for generating the vibratory modulation of the fluid (e.g., sound), the electrostatic fluid accelerator and include (i) an array of corona discharge electrodes; and (ii) an array of accelerator electrodes. According to one aspect of the invention, a capacitance formed by the corona and accelerator electrodes constitutes substantially all of the external capacitive loading to which the power converter stage is subjected. Various embodiments and/or implementations of the invention may include one of more of the aspects, features, etc. as described in the following sections.
1. Power converter stage having an internal capacitive loading that is substantially less than an external capacitive loading applied thereto.
2. Ionic wind modulation with discharge resistor.
3. HV bias maintained greater than Von at the maximum voltage anticipated for the loudest signal.
4. HV maintained at a level that is near or at the lowest level permitted by AC amplitude and incorporating a signal delay to provide a gradual bias adjustment.
5. Low and high frequencies separation features.
6. Enclosed loudspeaker.
7. Enclosure with the ozone filter.
8. Enclosed sealed loudspeaker filled with a nonreactive gas such as nitrogen.
9. Clear film embodiment.
10. Array and Phase Control Feature.
11. Unidirectional corona speaker.
12. Microloudspeaker with “needle-like” electrodes.
13. Double-sided loudspeaker.
14. Algorithm for different environmental conditions.
15. Ultrasonic cleaning of surfaces.
16. Acoustic weapon.
17. Floating loudspeaker.
18. Low Frequency and HF parts connected to ground potential to avoid or minimize unintentional/accidental shock hazard.
19. Spark sensing.
20. Expandable corona loudspeaker.
21. Tandem Configuration of Multiple EFA stages.
22. Phased driver signals applied to stages of tandem configuration of multiple efa stages.
23. Large array of EFAs to cover expansive areas such as theaters.
24. Focused ultrasonic acoustic actuator used as a High Intensity Focused Ultrasound (HIFU) actuator(s) for medical and similar procedures.
25. Method to transform acoustic source signal to compensate for distortions created by non linear pressure vs. voltage relationship in EFA loudspeaker.
26. Use of corona electrode temperature (Field enhanced thermionic emission) modulation to modulate discharge current and thereby create acoustic waves, especially at low and infra-low frequencies, without the need for oscillating high voltage signals.
27. Use of corona electrode temperature (Field enhanced thermionic emission) to adjust loudspeaker acoustic intensity by controlling corona electrode temperature. Allows for volume adjustment without needing to change high voltage bias or high voltage acoustic waveform amplification factor. Alternatively, both the voltage and temperature and voltage can be varied simultaneously.
28. Hybrid, EFA and electrostatic loudspeaker design.
29. Polar plot of loudspeaker.

### DESCRIPTION OF THE PREFERRED IMPLEMENTATION

The ensuing description provides exemplary embodiments only, and is not intended to limit the scope, applicability, or configuration of the invention. Rather, the ensuing description of the exemplary embodiments will provide those skilled in the art with an enabling description for implementing an example embodiment of the invention. It should be understood that various changes may be made in the function and arrangement of elements without departing from the spirit and scope of the invention.

A sound transducer for converting an audio signal into vibratory modulation of a fluid includes a HVPS (HVPS) and an electrostatic fluid accelerator (EFA) connected to receive the HVPS for generating the vibratory modulation of the fluid. The electrostatic fluid accelerator may include and EFA array having (i) an array of corona discharge electrodes, and (ii) an array of accelerator electrodes. HVPS may include (i) a control circuit responsive to the audio signal; (ii) a power input stage responsive to the control circuit for selectively supplying input power; and (iii) a power converter stage configured to convert the input power to a high voltage. The power converter stage may preferably have an internal capacitive loading that is substantially less than an external capacitive loading applied thereto. A capacitance formed by the corona and accelerator electrodes may constitute substantially all of the external capacitive loading to which the power converter stage is subjected.

Power Converter Stage Having an Internal Capacitive Loading Substantially Less than an External Capacitive Loading Applied Thereto.

Generally, HVPSs use one of three methods of high voltage generation (see e.g., Theory and Design of High-Voltage Power Supplies. Krichtafovitch at al. High Frequency Power Conversion, 1995, Conference, May 6-12, 1995, San Jose, Calif., page 147-157, incorporated herein in its entirety by reference). These methods include: (i) transformation of alternating current, (ii) accumulation of electromagnetic energy, and (iii) summing over of constant voltages.

The first method of transforming an alternating current is not well adapted to sound generation. The method requires a high frequency step-up transformer with a turns ratio of about 1:100. An inherent drawback is that all magnetic windings have some parasitic stray capacitance present in the many turns comprising its secondary winding. The reflected value of the parasitic stray capacitance is equal to the stray capacitance of the secondary winding times the square of the secondary to primary turns ratio. Primary current used for charging and discharging this parasitic stray capacitance is given as:

I_{avg}=4*f*U1*C2(N2/N1)²

where

I_{avg} is the average value of the primary “capacitive” current,

f is frequency,

U1 is primary voltage,

C2 is stray capacitance of the secondary winding,

N2 is number of secondary winding turns, and

N1 is number of primary winding turns.

For most high frequency transformers the value of the secondary winding stray capacitance is between 2×10⁻¹¹ F to 3×10⁻¹⁰ F. To reproduce acceptable sound having a highest frequency of 17 kHz the conversion frequency or “sample rate” should be no less that 34 kHz. For optimal sound generation this upper frequency should be even higher (e.g., 18-20 kHz) with a corresponding sampling rate of 40 kHz. For purposes of the present example we will use a conversion rate of 40 kHz and a primary voltage (after 115 V, 60 Hz rectification) equal to 162 V peak to peak (i.e., the a. c. voltage at the primary winding, U1.) We further assume a typical secondary voltage for an ionic wind application (i.e., the voltage applied to the electrodes or EFA portion of the device) to be about 15,000 V.

Therefore we can calculate that the average current value at the primary winding is in between

Iₐᵥ=4*162*40,000*(15,000/162)²*(2×10⁻¹¹−3×10⁻¹⁰)=(4.44−66.7) A.

From this we can calculate that the average power Pₐᵥ that is required due to secondary winding stray capacitance charging is equal to

Pₐᵥ=162*(4.44−66.7)=(720−10,800) W.

It can be seen that this parasitic power requirement is much greater than is needed for the actual sound reproduction function. The high power demands of such inefficient devices used to modulate a high voltage based on a direct transformation of the alternating current are not practical, being expensive and wasteful of power.

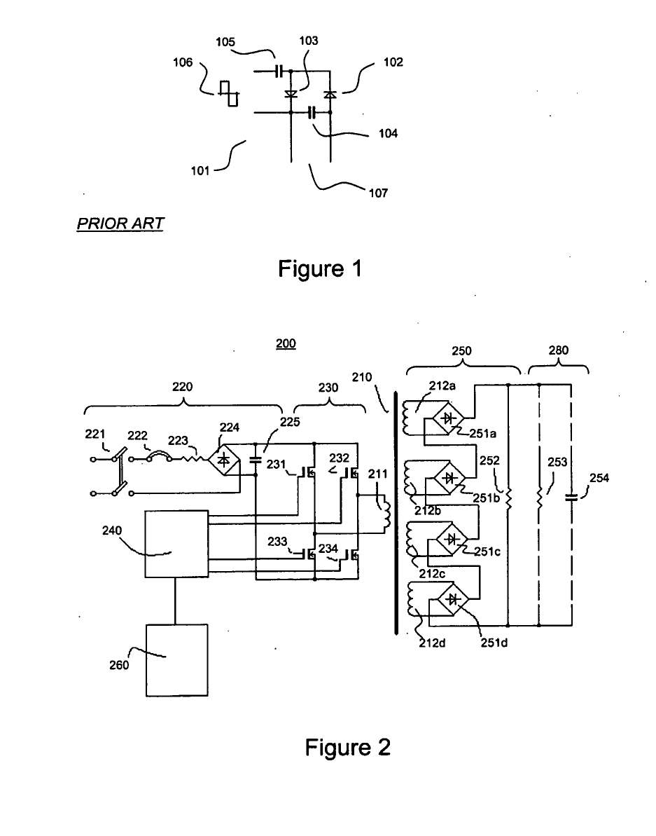

A method based upon the storage or accumulation of electromagnetic energy is used in devices like voltage multipliers. Voltage multipliers use a step-by-step accumulation of the electrical energy in a number of capacitors separated by high voltage diodes. A typical voltage multiplier circuitry 101 is shown in the FIG. 1.

Let us assume that initial voltages across capacitors 104 and 105 are equal to zero. During a first half of the AC cycle input voltage 106 has a positive polarity such that a current flows through diodes 103 and 105. Capacitor 105 is thereby charged to a voltage equal to the maximum (e.g. peak) value of input voltage 106. During this time capacitor 105 has accumulated electrical energy. It should be noted that output voltage is still equal to zero. During a subsequent second half of the AC cycle, input voltage 106 reverses its polarity and current flows through the series circuit of capacitor 105, diode 102 and capacitor 104. Capacitor 105 is discharged by this current while the capacitor 104 is charged. At this stage capacitor 104 is charged to a magnitude equal to maximum magnitude 106 while the voltage across the capacitor 105 becomes equal to zero. At the next stage capacitor 105 is charged to input voltage 106 again and, during still a subsequent stage, capacitor 104 is charged to the 1.5 time input voltage 106. Over the course of time the voltage across 104 (e.g., output voltage 107) increases as

2*106(1−½ⁿ),

where n is the number of AC cycles.

Thus, even in a simple voltage doubler rapid changes in the input voltage are not reflected by the output instantly. In more complicated voltage multipliers (e.g., those having multiple stages to further increase the voltage level) the process of voltage accumulation is significantly slower (e.g., delayed by further partial and/or entire cycles). Thus, such voltage multiplier circuits as well as other types of HVPSs utilizing the accumulation of the electrical energy are generally unsuitable for use in audio circuits and high voltage amplifiers.

One solution for instantaneous low voltage to high voltage conversion employs a summing over of constant voltage method. To provide suitable frequency responses, the constant voltages should be decoupled from each other in order to provide their sum. This may be accomplished by the transformation of a high frequency AC with several separate magnetic means (e.g., transformers or secondary transformer windings), voltage rectification of the high voltages AC, and summing of the resulting individual DC voltages.

FIG. 2 is a circuit diagram of the HVPS (HVPS) 200 connected to an Electrostatic Fluid Accelerator (EFA) 280. HVPS 200 includes low voltage rectifier stage 220, DC-AC converter stage 230, HV Transformer Rectifier 210 (including HV Stage 250). Low voltage rectifier stage 220 includes: resistor 253, capacitor 254, power switch 221, fuse 222, in-rush limiting resistor 223, input rectifier 224, filter capacitor 225; DC-AC converter stage 230 includes full bridge converter with four transistors 231, 232, 233, 234, driver circuitry 240 and control circuitry 260; HV Transformer-Rectifier 210, has a primary winding 211 and HV stage 250 includes several secondary windings 212 (four are shown as an example), HV rectifiers 251, each is connected to the secondary winding 212, bleeding resistor 252.

DC to high frequency AC inverter 230 includes four power transistors 231-234 controlled in a traditional full-bridge manner wherein diagonal pairs of transistors (either 231 and 234 or 232 and 233) are ON simultaneously while the other pair of diagonally opposed transistors is OFF. This switching creates a high frequency AC (or pulsed DC) voltage on the primary winding 211 of the Transformer-Rectifier 210. Primary voltage across primary winding 211 is stepped-up by each of secondary windings 212. Each of these secondary voltages is independently rectified by respective high frequency high voltage rectifiers 251. It should be noted that there is no filtering of the output voltage by any of these rectifiers circuits so as to provide for instantaneous output voltage (across the resistor 252) change in response to any primary voltage (e.g. across the primary winding 211) change. Filtering may be avoided by the use of a suitably high switching frequency, e.g., at least two times that of the highest frequency to be produced or reproduced.

EFA 280 is shown represented by its equivalent impedance in the form of resistive component 253 and parasitic capacitance 254. The only parasitic capacitance 254 as shown is present at the output in the form stray capacitance present in the EFA array itself. This capacitance 254 is very small, typically equal to 20−50*10⁻¹² F. Resistance 253 represents an electrical path for the corona current flowing from the corona electrodes to the accelerating electrodes. This resistance depends on the voltage across the array. To make an additional current path and accelerate the discharge of capacitor 254 (thereby improving circuit time response) an additional high voltage bleeding resistor 252 is placed in parallel with the EFA array.

Control circuitry 260 controls the time during which power transistors 231-234 are ON and OFF, i.e. duty cycle of the power transistors being ON. By doing so it controls the amount of energy that flows to the output (during ON time) and, therefore, the magnitude and/or duration (pulse width) of the output voltage.

A control circuitry 260 supplies driver circuitry 240 with an appropriate signal that is then transferred to the high voltage output, e.g. supplied to EFA. By changing the high voltage applied to the EFA (across the resistor 252) the corresponding ionic wind air speed is also changed. It has been experimentally determined that air speed may be changed rapidly with virtually no inertia, thereby instantaneously reflecting the voltage across the EFA. In order to change the output voltage the ratio of Time_{ON}/Time_{OFF} (i.e., the duty cycle) of power transistors 231-234 may be changed. The greater this ratio is the greater is the voltage across the EFA arrays and the higher the airflow generated by EFA.

There are different types of voltage modulation that are capable of controlling the ratio between Time ON/Time OFF. One method uses pulse width modulation (PWM), wherein the pulse duty cycle is changed while the frequency of the AC across primary winding 211 is constant.

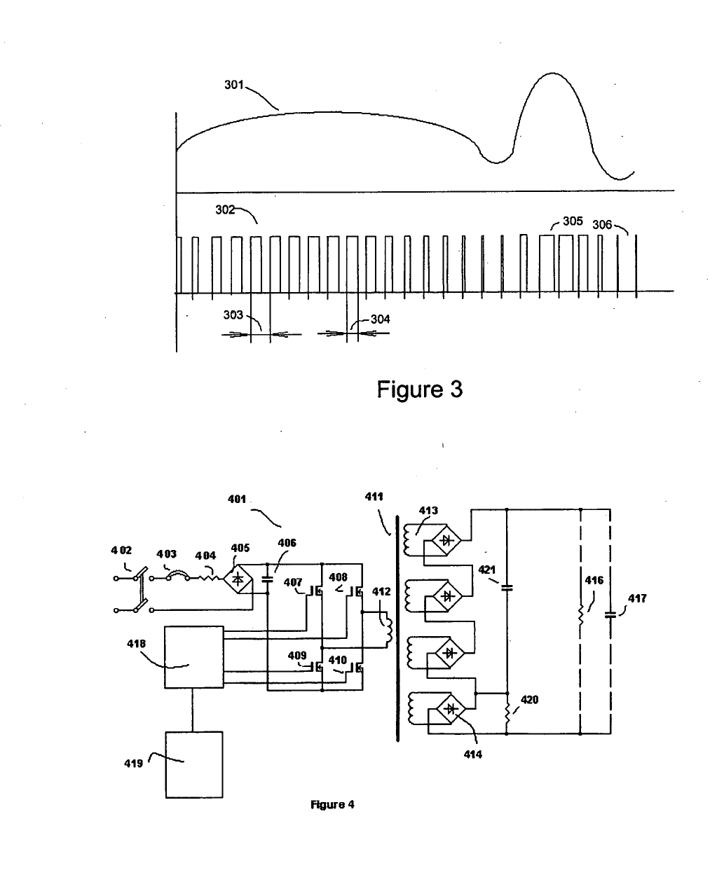

This type of modulation is shown in the FIG. 3 wherein the maximum magnitude of the airflow 301 (top of diagram) corresponds to the highest level of duty cycle (i.e., greatest pulse width or longest pulse duration) of the high frequency signal 302 (lower portion of FIG. 3). In the lower portion of the diagram a ratio of pulse width 304 to the period duration 303 is illustrate. It is shown that the greatest pulse width (and duty cycle value) 305 corresponds to the greatest magnitude of the voltage 301 while the lowest duty cycle 306 corresponds to the smallest duty cycle.

Other types of modulations known in the art (e.g., frequency modulation) that allow control of the amount of energy transferred to the output may also be used for sound generation.

Ionic Wind Modulation with Discharge Resistor.

The HVPS shown in the FIG. 2 has the disadvantage of a relatively large leakage current flowing trough bleeding resistor 252. This resistor is connected to full output voltage and it is not economical to discharge the full voltage via the resistor.

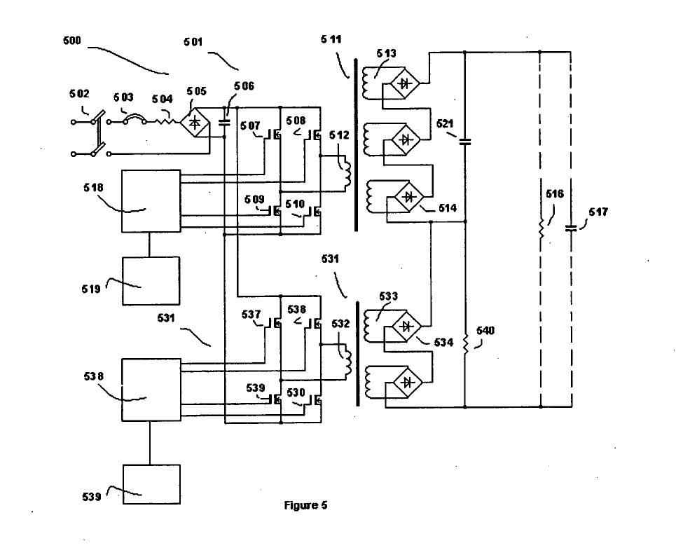

FIG. 4 is a circuit diagram of another HVPS with EFA capable of producing an acoustic sound. This circuitry is more energy efficient than that shown in FIG. 2. In this figure the HVPS 400 is connected to an Electrostatic Fluid Accelerator (EFA), which is schematically represented by it electrical equivalent load circuit comprising resistor 416 and capacitor 417. HVPS 400 includes power switch 402, fuse 403, in-rush limiting resistor 404, input rectifier 405, filter capacitor 406, full bridge converter with four transistors 407, 408, 409, 410, HV transformer 411, having a primary winding 412 and several secondary windings 413 (four are shown by way of example), HV rectifiers 414, connected to the secondary winding 413, bleeding resistor 420, HV filter capacitor 421, driver circuitry 418 and control circuitry 419.

HVPS 400 as shown in FIG. 4 works in a manner similar to that described above with reference to the embodiment of FIG. 2. A significant difference is that the output voltage (i.e., as present across capacitor 417) is equal to the sum of the voltages across the resistor 420 and the capacitor 421. If the capacitance of capacitor 421 is much greater than capacitance 417 of the EFA array, then the voltage across capacitor 421 will not change as rapidly as the voltage across the capacitance 417. For the sake of discussion, we can safely presume this voltage to be at the constant value. This presumption is valid, of course, when the modulation of the input audio signal is in “mode A”, i.e., class A operation wherein variations in input signal polarities occur within the limit of CUTOFF (e.g., corona onset) and SATURATION (e.g., electrical breakdown including sparking and/or arcing). (Note that embodiments of the present invention may also operate in Class AB mode wherein some limited signal distortion may be acceptable.) The voltage across the resistor 420 will be proportional to the immediate voltage magnitude across the primary winding 412. It should be noted that EFA produces air flow (and sound therefore) only when the voltage across EFA array is in between the corona onset voltage and the electrical breakdown voltage. Thus, the voltage across the capacitor 417 should always be within this range. The best result and sound range would be achieved, however, when the voltage across the capacitor 421 is also within this range and, most commonly, in the middle of this range. If, for instance, the corona onset voltage is equal to 8,500 V and the electrical breakdown voltage is about 19,000 V, then the voltage magnitude across the capacitor 421 would be within these limits, say, in the middle of it, i.e., around 13,500 V. If this condition is met then voltage AC component across the resistor 420 would reach +5,000 V without breakdown and dropping below the corona onset voltage. That gives the best sound quality (minimal dynamic distortion) and range (i.e. loudness).

In the FIG. 5 still another implementation of the current invention is shown. The EFA (represented by its electrical load equivalent in the form of capacitor 517 and resistor 516) is connected to HVPS 500, that, in turn, consists of two high voltage power supplies—HVPS 501 and HVPS 531. HVPS 501 and 531 have similar structure and are controlled by separate and distinct control circuits 519 and 539. Control circuit 519 provides basically same control output during EFA operation. Therefore, the output voltage (i.e., across the capacitor 521) is substantially constant.

Control circuit 539 provides modulated signal with pulse width changing with accordance with input audio signal magnitude. As a result, the voltage across the resistor 540 changes or varies in proportion to that of the input audio signal. The sum of these voltages is applied to the EFA (517 and 516). This resulting voltage should be maintained within the same margin between the corona onset voltage and the electrical breakdown voltage as previously described. Using the same numeric values as in the previous discussion, the voltage across capacitor 521 should be maintained at about 13,500 V, while the AC voltage across the resistor 540 may be small (quiet sound) or may reach up to but should not exceed an instantaneous peak-to-peak value of 5,000 V (loud sound).

In the FIG. 6 a loudspeaker arrangement 600 includes two EFAs 607 and 608 capable of producing sound. Three HVPSs 601, 602 and 603 are connected in such way that the voltage across each EFA is a sum of the voltages across 601 and 602 for EFA 607 while it is the sum of voltages across 601 and 603 for EFA 608. The capacitor 604 has substantial capacitance that is much greater than the parasitic capacitance of the EFAs 607 and 608. Discharging resistor 605 should have a relatively small resistance R₆₀₅ as explained below. This resistance should be small enough to discharge EFA parasitic capacitance C_{EFA} with required or desired maximum audio frequency Fₘₐₓ to be produced or reproduced. Time constant T is defined by this maximum audio frequency and is equal or close to the frequency Fₘₐₓ half period: T=R₆₀₅*C_{EFA}<½Fₘₐₓ.

If, for instance, maximum frequency is equal to 20 kHz and EFA array's capacitance is equal to 100 pF, then the maximum value of R₆₀₅ should be equal to 1/(2*20,000)*100*10⁻¹²=250 kOhm. The maximum power P₆₀₅ loss on this resistor depends on the AC signal amplitude at the 602 or 603 output. If, for instance, this voltage is equal to 5,000 V, then P₆₀₅ is equal to 5000²/250*10³=100 W. This power is much less than would be otherwise consumed by, e.g., a step-up transformer arrangement as discussed above (720−10,800) W.

For the arrangements shown in the FIGS. 4, 5 and 6 it is important that the internal (stray or parasitic) capacitance of the AC high voltage power supplies (or portion of it, such as resistor 420 in FIG. 4) should be as small as possible and, preferably, not greater than a value of any stray capacitance between the EFA electrodes.

An important aspect of the current invention is directed to producing an acoustically modulated airflow with high sound quality, i.e., with high fidelity so as to faithfully reproduce an audio signal. To achieve improved fidelity, it should be understood that, according to Kotelnikov's theorem (also known as the Nyquist-Shannon or the Whittaker-Nyquist-Kotelnikov-Shannon sampling theorem), when sampling a signal (e.g., converting from an analog signal to digital), the sampling frequency must be no less than twice the bandwidth (i.e., the highest frequency) of the input signal in order to satisfactory reconstruct the original waveform from the sampled version. Thus, in order to produce a sound frequency F1 the switching frequency F2 should be at least twice as great as the desired frequency F1 of the sound. Conversely, a sampling frequency F2 of 20 kHz as might otherwise be used cannot theoretically produce sound with frequency greater than 10 kHz. In as much as human hearing may respond to sound frequencies as high as 20 kHz, power converters (or HVPSs in this case) accommodating a maximum frequency of 10 kHz are inadequate to provide high fidelity sound reproduction. For example, the CCITT G.722 Wideband. Speech Coding Standard, generally considered to be a low fidelity “commentary grade system” uses a sampling rate of 16 kHz to provide a bandwidth of 100 to 6.4 kHz. In contrast, sample rates of 22.05, 24, 32, 44.1 and 48 kHz are used to provide high quality response audio, the high rates supporting a robust bandwidth of 20 Hz to 20 kHz. The HVPS described provide the required frequency response needed for high fidelity sound production and reproduction.

### HV Bias Maintained at or Slight Above Vₒₙ at the Maximum Voltage Anticipated for the Loudest Signal.

Another feature of embodiments of the current invention includes controlling a high voltage bias voltage V_{B} such that it exceeds the corona onset voltage V_{O} by an amount sufficient to ensure that the maximum AC voltage component V_{AC} does not exceed the difference between V_{B} and V_{O}. Conversely, this difference should be as small as possible in order to decrease energy loss trough the bleeding resistor. In other word the best power consumption is achieved when V_{AC} does not exceed the difference between V_{B} and V_{O} and stays close to it. When a loud sound is expected V_{B} may be increased in magnitude. During a silent period V_{B} may be equal or even lower than V_{O}. That is,

$${V}_{B} = {V}_{0} + \frac{{V}_{{AC}_{PP}}}{2} + C$$

where

V_{B} is a low frequency of DC bias voltage level;

V₀ is a corona onset voltage level; and

V_{ACPP} is the peak-to-peak magnitude of a high frequency voltage component

C is zero or some small value (e.g., the “difference” mentioned above) during sound production and may be negative when no sound as to be produced such as in a standby mode.

### HV Maintained at the Lowest Level Permitted by AC Amplitude, Delay in Signal.

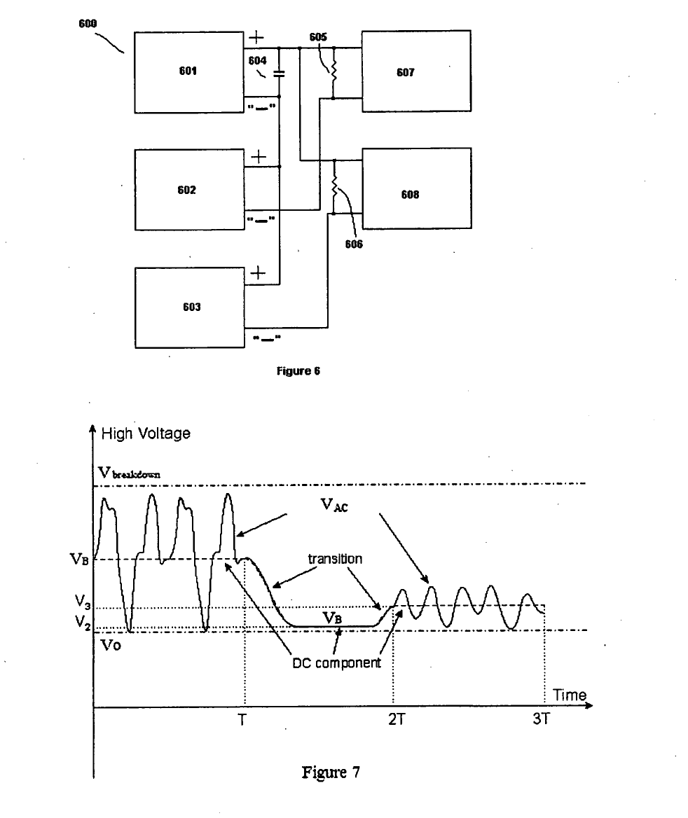

It is possible to provide both low power consumption and maximum possible amplitude for an acoustic signal at the same time by modulating a level of a high voltage DC component according to an amplitude of the AC component, i.e. to change V_{B} in accordance to the V_{AC} magnitude. It is desirable to have V_{B} as close as possible to V_{O} in order to decrease power consumption while the difference between V_{B} and V_{O} determines the maximum possible amplitude of high voltage AC component which has the largest value when V_{DC} is in the middle between V_{O} and V_{breakdown}. As a result maintaining a high voltage DC component at a constant value in the middle of this range does not provide both low power consumption and maximum possible amplitude for acoustic signal. One implementation of this idea is illustrated in FIG. 7.

With reference to the waveforms depicts in FIG. 7, an acoustic signal is divided or partitioned into three shorter constituent acoustic signal segments each of some length T. Before being applied to the EFA, each segment is analyzed to find maximum negative amplitude of its corresponding high voltage AC component (e.g., the maximum instantaneous negative-going peak value). Then a level of the high voltage DC component is set to some corresponding bias voltage level V_{B} for the duration of that segment. Thus, for three short signals shown in FIG. 7 high, voltage DC component is set to V_{B}, V₂, and V₃ respectively. In order to make changes from one level of DC component to another unnoticeable, transition (e.g., from V_{B} to V₂ and from V₂ to V₃) should be gradual, i.e., sufficiently slow as to be inaudible (e.g., with a characteristic frequency of less than 20 Hz). Therefore, for each acoustic signal of length T high voltage DC component is adjusted to the lowest possible value thus reducing electric current and power consumption. Length T does not necessarily need to be a constant value: it can be adjusted during operation of the EFA, i.e., the “corona speaker”. According to another embodiment, a level of the high voltage DC component can be changed continuously in the anticipation of sound intensity changes.

In the case of the reproduction of previously recorded audio or sound recording, the entirety of the audio signal or audio file to be reproduced may be scanned in advance identity sound intensity levels present in the recording. Then the DC component, i.e. V_{B} is constantly or continually adjusted as necessary during playback so as to anticipate the AC component magnitude. The speed of DC voltage adjustment (dV/dT) should be of such value that does not create any audible air fluctuation or artifacts. In general, the Human ear is capable of responding to sounds having a frequency or at least 20 Hz, but not significantly less. Therefore, the maximum speed of DC change should be below that frequency and should not have any components generating artifacts within an operating/audible range to be produced (e.g., 20 Hz-20 kHz).

### Low and High Frequencies Separation.

Another implementation of the current invention may include a separation between low-frequency and high-frequency components of the audio signal. In theory, an audio signal may be converted to the corresponding high voltage, i.e. AC component, with the help of step-up transformers. However, such transformers should have rather linear characteristics for a whole range of the frequencies containing in the original audio signal. While high quality/performance transformers do exist, (Electrostatic loudspeaker transformers, e.g., ESL transformers, for instance), given the relatively wide range of frequencies (20 Hz to 20 kHz) and large turns ratio (1:100 or even more) these transformers are typically bulky and expensive.

As used herein, the term “low-frequency” includes the lowest one percent (1%) and, more preferably, the lowest one-half percent (0.5%) of the maximum operating frequency of a device. For example, in the audio domain, low frequencies include DC through 200 Hz and, more preferably, DC through 50 Hz, depending on the application. The term “high-frequency” includes those frequencies above those considered to be “low-frequencies” and may include what might otherwise be considered mid-frequencies. For example, in some applications, low-frequency signals may include bass frequencies as supplied to a woofer component of a stereo system, mid-frequencies as supplied to a midrange speaker element, and high-frequencies to a “tweeter” component. Of course, as embodiments of the present invention are applicable to a wide range of frequency applications, the terminologies used herein are to be given the appropriate interpretation in view of the context of use.

Conventional transformers cannot transform DC voltage, for instance. Therefore, transformer use is limited to the medium and high frequency range (e.g., from 200 or 400 Hz to 20 kHz). Very high frequencies are corrupted by the transformer due to inherent parasitic leakage inductance and stray capacitance. The leakage inductance creates a large impedance at high frequencies. The inductance's L impedance Z_{L} is linearly proportional to the frequency F: Z_{L}=2πF L. The higher the frequency the greater is the value of Z_{L}. At certain frequencies this value becomes comparable to the resistance of the EFA loudspeaker and interferes, limits and degrades sound quality (e.g., fidelity).

The stray capacitance of a step-up transformer also interferes with sound quality. Both leakage inductance and stray capacitance depend on the number of turns present in the windings of the transformer. In particular the leakage inductance is proportional to the number of turns squared. That is, by doubling the number of turns the value of leakage inductance is quadrupled. At the same time, to cover lower frequency range, the number of turns should be increased, otherwise the magnetic core may be saturated. This consideration represents a natural limit for conventional audio transformers. High quality transformers can cover frequency range of from 5 Hz to 20 kHz but are very expensive and heavy.

To solve this problem, a new way of producing high fidelity sound is hereafter presented. In embodiments of the present invention an input audio signal is split in two parts: a high-frequency portion and a low-frequency portion. The high-frequency portion is converted to a high voltage AC component using one or more step-up transformer(s). These transformers can be designed to handle a relatively limited or narrow frequency range, for instance, from 1 kHz to 20 kHz. This results in a large savings in the materials (magnetic core and windings) used to manufacture the transformer as compared to a step-up transformer capable of operating over a wider range of frequencies of, for example, 20 Hz to 20 kHz.

The low frequency portion (e.g., 20 Hz to 1 kHz) is generated by the inertialess DC HVPS (such as the one described with reference to FIG. 2) that is capable of increasing a high voltage rapidly within and even outside the maximum frequency of said low-frequency range (1 kHz in the above example). The decrease of this DC voltage is provided by bleeding resistor such as bleeding resistor 252 of FIG. 2.

For the stereo or surround sound reproduction at least two Electrostatic Loudspeaker (ESL) Transformers should be used: one for the left speaker channel and one for the right speaker channel. The two transformers are configured to feed a pair of EFA arrays to provide stereo sound. The secondary winding of the ESL Transformer should be connected to either the accelerator or corona electrode of the EFA array and to the secondary ground of the DC HVPS while the low-frequency DC HVPS should be connected to the ground and to the another electrode. i.e., either corona or accelerating one. If each EFA array consists of a flat panel geometry and is pointed at a center point, the ideal listening position would be at that center point.

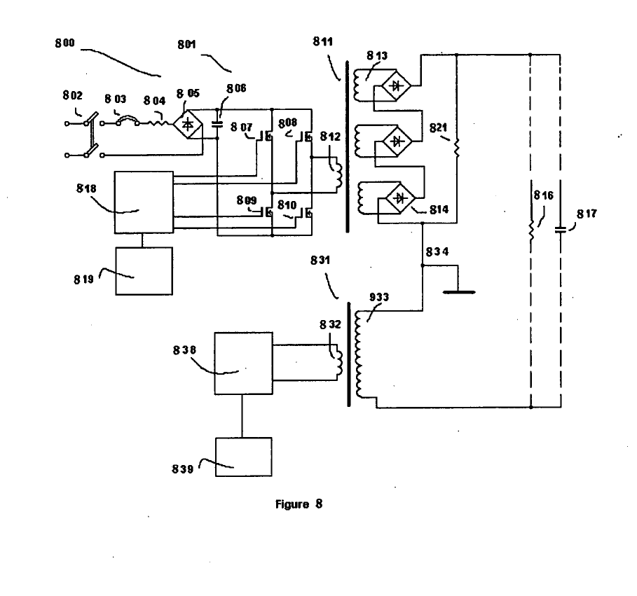

Embodiments of the present invention may stipulate a cross-over and divert frequencies at cut-off line between the high-frequency and low-frequency portions of the audio signal (assuming that this division may be different for different applications). The signal is bifurcated so that all the frequencies above the cut-off frequency go to the ESL Transformer and frequencies below (1000 Hz in our example) to the HVPS such as the ones described with reference to FIG. 2 or 3. This hybrid combination provides full frequency response to the EFA arrays. FIG. 8 is a circuit diagram of the HVPS and ESL Transformer supporting high frequencies and a switched HVPS handling low frequencies that, in combination with an EFA produce a wide range of acoustic sounds.

In FIG. 8 HVPS 800 is connected to an EFA, which is represented by its load circuit equivalent as resistor 816 and capacitor 817. DC HVPS 801 include power switch 802, fuse 803, in-rush limiting resistor 804, input rectifier 805, filter capacitor 806, full bridge converter with four transistors 807, 808, 809, 810, HV transformer 811, having a primary winding 812 and several secondary windings 813 (three are shown as an example), HV rectifiers 814, each is connected to the secondary winding 813, driver circuitry 818 and control circuitry 819. Bleeding resistor 821 is connected to the output of DC HVPS 801. DC HVPS 801 and step-up HV transformer 831 share a common connection pint (in most cases a ground point) 834. Step-up HV transformer 831 consists of a primary winding 832 and a secondary winding 833 and receives its audio signal from an audio source 839 fed into an amplifier/receiver 838.

It should be understood that other configurations of the DC HVPS disclosed in the current application (for instance but not limited to those shown in FIGS. 4, 5 and 6) may be used in combination with step-up transformers, the former for low frequencies and the latter for high frequencies.

A preferable configuration is such that the “more positive” potential be connected to the corona electrode while more negative potential of the combined power supply would be connected to the accelerator electrode. The absolute voltages are, in themselves, unimportant, i.e., it does not matter whether these potentials are positive or negative. Instead what matters is the difference between the potentials. For instance, a “negative” potential may be at “minus 5,000 V” while the relative “positive” potential is at “plus” 10,000 V. In this case the difference between the corona electrode and the target electrodes is “plus” 15,000 V. If the corona electrode is under “minus” 1,000 V and the target electrode is under “minus’ 16,000 V, the difference between the respective potentials is the same. i.e. “plus” 15,000 V. There is no difference in the performance for those two cases.

Preferably, but not exclusively, for the convenience of the control, each portion of the power supply is connected to one respective terminal to the potential, close to the ground. As a result, the corona electrode will be at the positive potential with respect to the ground potential while the accelerator electrode is under negative potential with respect to the ground potential. The difference between the common point potential and the ground potential should be no more or around the maximum rectified voltage of the main. That is if main caries 110 V sinusoidal voltage, the common point should differ from the ground at about 110*sq/root (2)=155 V. If main carries 220 V, the difference suppose to be around 310 V and so forth.

The sum of these two voltages is not constant but is proportional to the acoustic signal. It should be preferably kept within the same range (i.e., between the corona onset voltage and the voltage that would cause arcing within and/or between the EFA arrays) at any time. This is because sound is not reproduced below the corona onset voltage or beyond the arcing voltage which is otherwise undesirable.

### Loudspeaker Enclosure.

For some applications the loudspeaker as herein disclosed in the current invention may be used not only for sound generation but for air movement, ventilation, purification and disinfection since EFA has natural ability to do all the above. Conversely, for some applications, any perceptible air movement may not desirable since it may disturb listeners. It was discovered, however, that air movement may be blocked by some media without attenuating vibratory motion of the air as required to transmit sound. In such case, the EFA may be placed and/or mounting with an enclosure (i.e., a “box”) or placed against solid structure of material (such as a wall) adjacent an air intake side of the EFA. Such an arrangement restricts airflow but allows air modulation and does not restrict sound generation or transmission.

The EFA may be covered at its air outlet with some soft media (such as cloth) that allows sound penetration (i.e., acoustically transparent material) but restricts airflow. That is, the media transmits sound pressure variations but limits or inhibits airflow. Alternatively, the EFA may be placed in the box with one side covered with sound penetrating media similar to that of conventional electromagnetic loudspeakers.

Enclosure with Ozone Filter.

Another improvement may be made if an EFA is placed into or mounted within an (airtight) enclosure that contains ozone-scrubbing materials such as activated coal, charcoal, carbon or other ozone mitigating substances. In this case still air within the enclosure will be scrubbed from ozone, while no ozone will escape from the enclosure. According to one configuration, an ozone filter is positioned at the outlet side of the EFA, covered with an acoustically transparent cloth or similar material, while other sides of the enclosure are covered or made of some solid material such as wood or plastic.

It has been found that sound intensity and quality are not affected by such enclosure, but that there is no escape of ozone generated by the corona discharge operation.

Applying an ozone catalyst to a sound invisible material, like speaker cloth mesh, would further assist in minimizing net ozone production. The catalyst must be applied so that there is a path for air to move from the EFA array through the speaker mesh containing the catalyst. The ozone catalyst can also be in a cartridge form using a honeycomb like structure. The cartridge would encapsulate the output of the EFA array so that air does not bypass the cartridge.

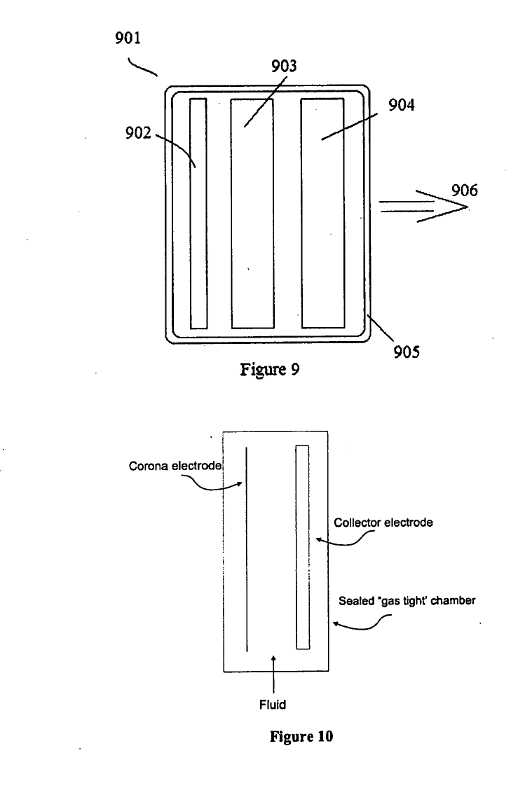

In FIG. 9 one of the possible implementation of such loudspeaker 901 is shown. As depicted therein, an EFA includes corona electrode 902 and accelerating electrode 903, placed into and/or mounted within enclosure 905 that allows sound 906 to penetrate through. Ozone scrubber 904 is positioned and/or mounted at the outlet of the EFA. Since air velocity through the ozone scrubber is relatively low the efficiency of this scrubber in ozone removing is very high. At the same time neither air flow nor ozone escape outside of enclosure 905, i.e. where they may be detected by, be objectionable or harmful to nearby listeners.

Enclosed Sealed Loudspeaker with Nitrogen Atmosphere.

The corona electrodes as well as the accelerating electrodes are prone to both chemical and mechanical deterioration. For example, dust may settle onto the electrodes as well as airborne chemicals may be converted to more solid materials in the plasma region surrounding the corona electrodes ionizing edges. In some cases the material constituting the corona electrode may be oxidized.

To avoid these drawbacks, of the proposed loudspeakers may include an EFA placed in a sealed enclosure or chamber having an atmosphere that is free of dust and chemicals. The atmosphere may further limit or eliminate oxidizing components such as oxygen. Media within the enclosure or chamber may include nitrogen that does not allow any material to oxidize.

Further it is possible to include a getter material into a sealed loudspeaker to ensure low concentrations of gasses such as oxygen. Common getter materials include Al, Mg, Th, U, misch-metal and Ba.

In one implementation the fluid within the chamber could be gaseous N₂, in another implementation it could be liquid N₂, in another implementation it could be H₂. In another implementation a fluid could be used that eliminates the production of ozone from a corona discharge.

Fluid composition and pressure within the chamber can be altered in order to produce optimized characteristics for a given application, such as increased voltage range between corona onset and media breakdown, efficiency of electrical to mechanical conversion, maximum acoustic power output density, increased lifetime of device by reducing mechanical or chemical etching or deposition on electrodes, and reduced or eliminated ozone and other corona discharge by-products.

The chamber (i.e., inside of the enclosure) may be filled with high electrical breakdown gas, for instance, Sulfur Hexafluoride or SF6. Being pressurized, such gas can withstand much higher voltage between the electrodes and is thereby capable of producing a more powerful sound pressure. A gas with low ion mobility may be selected in order to increase the efficiency of the electrical to mechanical transduction and increase the efficiency and or acoustic magnitude of the device.

On the other hand, some larger particles or aerosol may be introduced into the gas atmosphere within the enclosure. Such may increase media density and as a result sound intensity. However, with such a high pressure gas sound may be distorted. Therefore, a control system may be configured to adjust its transfer function to eliminate that possible distortion. Adjustment and/or selection of a suitable transfer function may be accomplished by various means and methods including, for example, a sampling/feedback arrangement (e.g., using a microphone to monitor audio output response and automatically equalize system frequency response characteristics), prestored settings for typical room environments and configurations, etc.

Material used to seal the chamber can be used to alter sound quality as desired, using different materials, tension, thickness, temperature, etc. thus changing the transfer function of the chamber material to the acoustic energy from the EFA actuator. Chamber material may also be used as a resonant surface.

Chamber materials may be made out of multiple materials in different locations of the chamber in order to optimize the “acoustic signature” or transfer function of the Chamber.

Chamber walls may act as both a barrier to contain a fluid and as a collector electrode. In this case at least a portion of the chamber should be made of conductive or semi-conductive (i.e. a partially conductive) material.

Chamber geometry may also be used to alter sound directionality. For example, a flat shaped EFA provides best sound quality and intensity for the listeners who are placed directly in front of the EFA outlet. However, this shape and/or geometry provides reduced sound quality for the listeners who are off to one side of and nor directly in front of the EFA. Making the chamber curved or bent outwardly provides a more uniform and even distribution of the sound output from the EFA so that a larger area of listeners may be serviced.

A schematic drawing of the sealed EFA a shown in FIG. 10. As depicted therein, a corona and accelerator electrode array constitute an EFA acoustic actuator contained within a sealed chamber. The chamber acts to separate the internal fluid of the chamber with that of the fluid exterior to the chamber. The acoustic energy created by the EFA can be transmitted through the material of the chamber into the external environment.

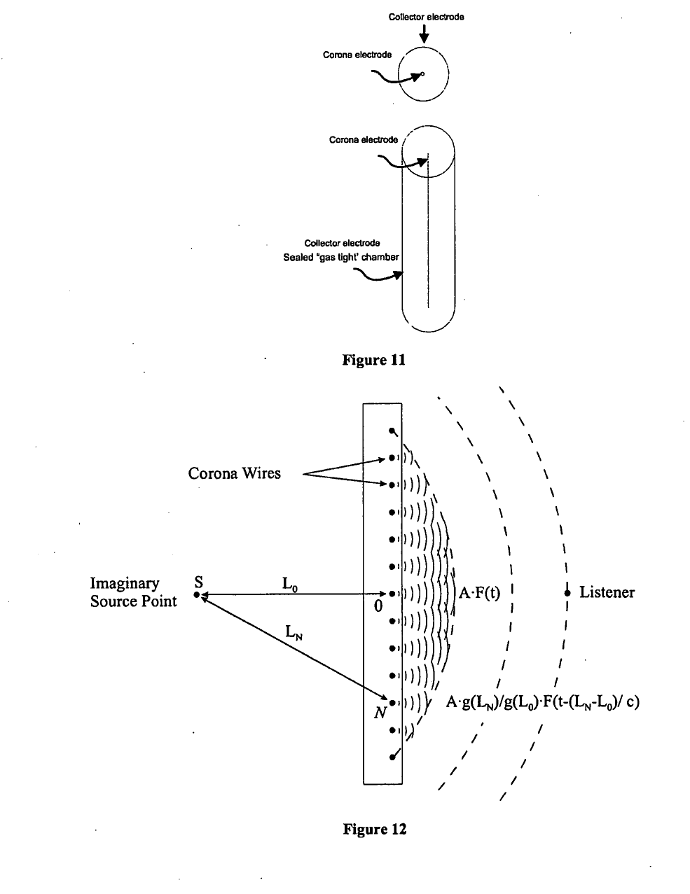

Another implementation of the airflow barrier at the EFA outlet is shown in FIG. 11. Here the corona electrode is located proximate the outer wall (i.e., barrier) that is made of the conductive material. This conductive barrier acts as an accelerating electrode and is connected to the HVPS in a manner shown in the previous circuit and block diagrams. Taking into account that the corona current density is very small the conductivity of this barrier may be much smaller than that of metal. For example, the barrier may be made of some insulating material, such as plastic or even a film with deposited (impregnated, plated) conductive media in the volume or on an exterior surface. The barrier may be made of semi-conductive plastic or any material with conductivity greater than of electrical insulators. It should be understood that more than one corona electrode may be placed inside of the chamber against the conductive or semiconductive barrier or a wall.

Preferably I the case of materials with poor conductivity, it may be beneficial to use more conductive (i.e., wire-like) components located on the semiconductive material to enhance overall conductivity. These conductive parts may be connected to the HVPS or may simply be located on these semiconductive materials to ensure more even electric potential distribution.

Optically Transparent EFA with Clear Film Barrier.

According to another embodiment, a semiconductive barrier may be made of clear plastic sheet or film that enables an EFA that is relatively small in size and, for some cases flat, but also virtually invisible. Such an EFA consists of a set of corona electrodes made of very thin wires and clear conductive film as the accelerator electrodes. Such clear conductive films are commercially available from, for example, CP Films, Inc. (http://www.cpfindusprod.com/2.7.asp) and other companies.

A grid made of thin, virtually invisible, wires may be placed opposite the corona electrode surface. These wires may or may not be directly connected to the HVPS.

To ensure safety of the listeners the outer wall (film, grid) should be connected to some safe potential level, i.e. grounded.

### Array and Phase Control.

Sound created by a device according to embodiments of the present invention, is a combination of acoustic waves produced by each individual sound patterns generated by one wire and two nearest accelerator electrodes with a larger set of array of corona wires and accelerator electrodes comprising an EFA. Therefore, each pattern works as an individual loud speaker and a person listening to sound generated by a EFA receives a plurality of sound waves that are perceived as the algebraic or vector sum of acoustic signals coming from set of line sources (patterns). By appropriate control of the drive signals provided to each of the corona wires it is possible to create a perceived effect that sound is emanating from a single line source. This effect can be achieved by appropriately adjusting the timing (and/or phase) and intensity of the high voltage applied to each corona electrode or to each target electrode or to both and consequently the acoustic signals emanating from each individual pattern. Such sound control utilizes concept of Wave Field Synthesis that is based on a Huygens principle about wave propagation.

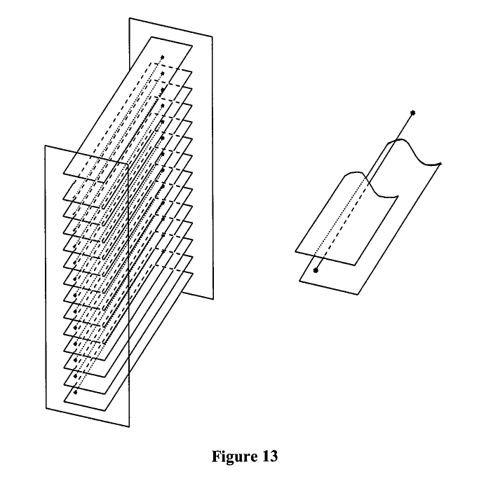

Referring to FIG. 12 by way of example, consider a set of corona wires of a EFA. For simplicity one can assume that positions of acoustic line sources coincide with corona wires. Point S represents location of a desired imaginary sound source. In three-dimensional space the sound source is represented by an imaginary line along an axis going through point S perpendicular to a plane containing the drawing. A corona wire 0 is the central wire of wire array. The acoustic signal generated by wire at position 0 can be defined as A·F(t), where A is its magnitude and F(t) is some function of time. The acoustic signal of any other wire N should be delayed by some time interval equal to a ratio of the difference (L_{N}−L₀) and the speed of sound c through the medium, in this case air (i.e., c≈331.4+0.6T_{C} m/s, where T_{C} is the Celsius temperature). Here L_{N} is the distance between wire at position N and point S and L₀ is the distance between wire at position 0 and point S. Thus, for wire N the signal should be delayed by (L_{N}−L₀)/c. As a result, time dependent part of acoustic signal from wire N can be expressed as F(t−(L₁−L₀)/c). Note that difference (L_{N}−L₀) can be negative if L_{N} is less than L₀. The magnitude of acoustic signal from wire N can be expressed through magnitude of acoustic signal from wire 0 as A·g(L_{N})/g(L₀), where g(L) is a function of distance L. The acoustic (and electrical) signals driving the remaining corona wires should have a similar form. As a result, the sound produced by each of the wires will be additive (i.e., constructively interfere) along line S such that a listener would perceive that the resultant sound emanates from this imaginary location (i.e., “line” in space).

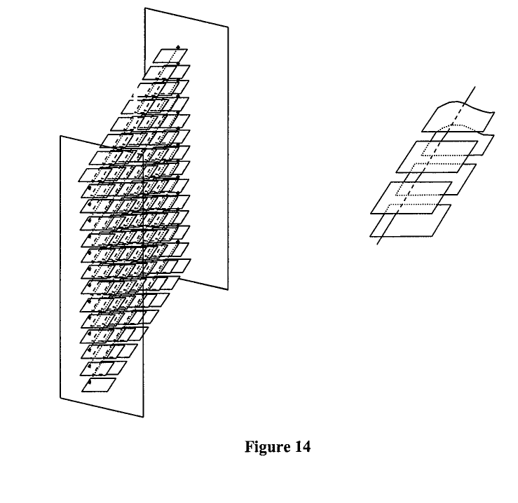

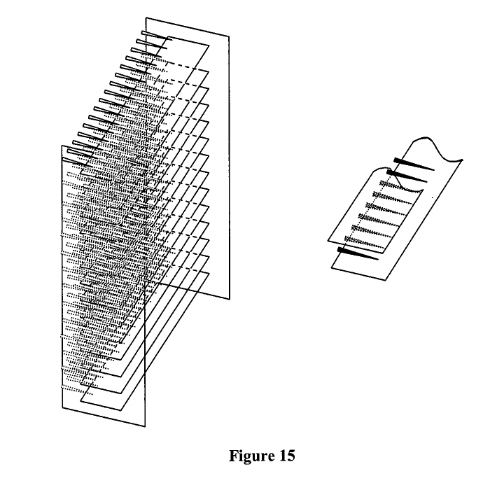

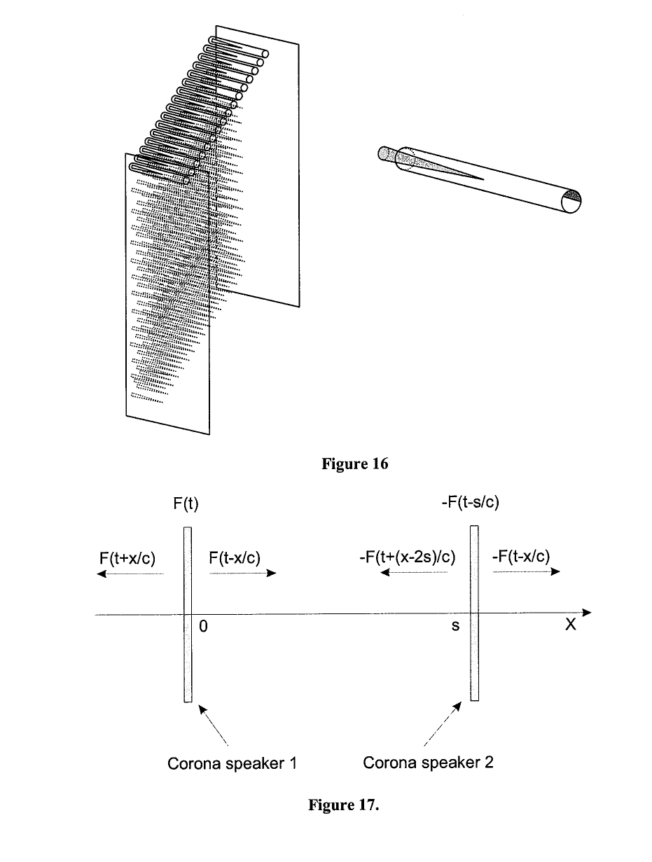

For the phase array, one can not only produce a line source of sound but produce a point source of sound by using many individual point sources as shown in the FIG. 13 through FIG. 16. In FIGS. 13-16 different configurations of the corona electrodes and accelerating electrodes are shown. Each electrode of a group of the electrodes may by connected to an individual HVPS or to one HVPS via different time delaying circuitries in order to produce, for example, a 3D sound image or 3D sound movement for the listeners.

A specific acoustic output pattern (phase array like) may be created using a single static array with only a single HVPS by creating a specific geometry with the array to send signals with different phase to each other such that it causes predetermined constructive and destructive interference in a 3D space.

### Unidirectional Corona Speaker.

The EFA loudspeaker described above transmits sound in both directions: in front and back of the EFA. However, by using two EFA loudspeakers it is possible to create a system that will transmit acoustic waves in one direction and will not transmit acoustic waves in the opposite direction. Such system is shown in FIG. 17, where two identical corona speakers are separated by a distance s. Sound from speaker 1 propagates in both directions. At the right, acoustic wave has form F(t−x/c), where F is some function, x is a coordinate along line connecting two corona speakers, and c is the applicable speed of sound. For simplicity it is assumed that distance s is sufficiently small that dependence of amplitude of the signal on the distance from the speaker can be neglected. At position of corona speaker 2, acoustic signal from the first corona speaker is F(t−s/c). If acoustic signal from corona speaker 2 is −F(t−s/c), then it will cancel a sound signal from speaker 1 at the space to the right from speaker 2. As a result, there will be no acoustic wave propagating to the right from speaker 2. In contrast, at the left from speaker 1 the total acoustic signal will be F(t+x/c)−F(t+(x−2s)/c) and in general it will not be equal to zero. Therefore, the system of corona speakers as shown in FIG. 17 will transmit sound to the left and will not transmit sound to the right.

Microloudspeaker with Needle-Like Electrode.

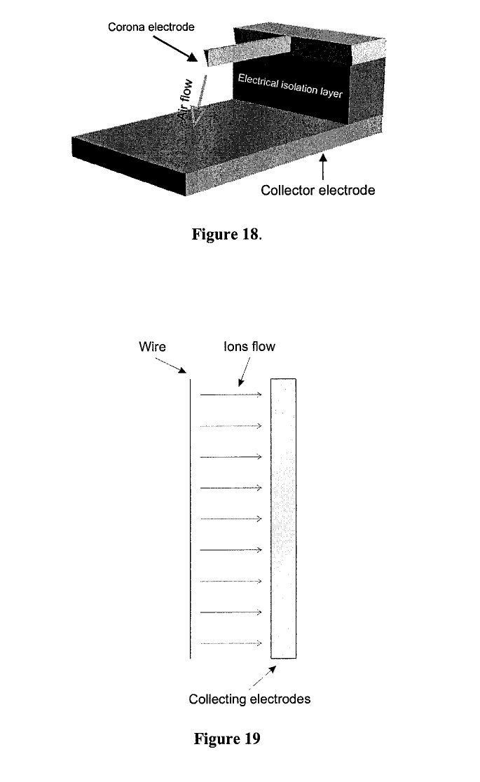

Due to the novel method of acoustic transduction provided by the electrostatic corona based loudspeaker, speakers can be created over a very large range of sizes and scales. A mini-scale loudspeaker may be created with an active volume on the order of one cubic millimeter or smaller. In order to generate a corona discharge at very small scales, a corona electrode with very high tip curvature is required to generate the high electric field gradient necessary for stable corona formation. In one implementation, a mini-scale loudspeaker can be created using Deep Reactive Ion Etching to form a high tip curvature “needle” electrode. The high tip curvature needle electrode is positioned on the order of hundreds of micrometers or single digit millimeters from a accelerator electrode during operation. One implementation of a mini-scale loudspeaker is shown in FIG. 18, using a cantilever-to-plane geometry.

As depicted in FIG. 18, a mini-scale loudspeaker could be used individually when a point sound source is required, or may be combined with a multitude of mini-scale devices. In one implementation the mini-scale loudspeaker may function as a speaker in a headphone, headset or earphone.

### Double-Sided Loudspeaker.

One arrangement of corona wires and accelerator electrodes forming a single-sided loudspeaker is shown in FIG. 19. The single-sided loudspeak consists of one set of corona wires and one set of accelerator electrodes. Such single wire-accelerator electrode combination can be successfully used to move air and to produce acoustic signals. However, it also has some shortcomings. First, it produces bulk airflow in the direction from wires to accelerator electrodes even when acoustic signal and consequently acoustic velocity are zero. Second, single wire-accelerator electrode combination may distort acoustic signal at high frequencies. This distortion may occur due to the fact that energy stored in the system can not be released immediately and high voltage electric potential difference between wire and accelerator electrodes may not necessarily decrees as fast as needed for acoustic signal.

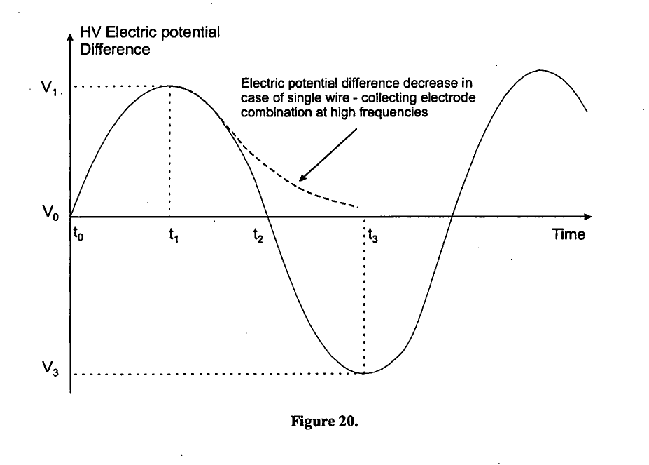

In order to explain this effect in more details, reference is made to FIG. 20. Here solid line shows an applied high voltage electric potential difference as a function of time needed to obtain a desired acoustic velocity. During the first time interval (from t₀ to t₁) electric potential has to increase monotonically from initial value of V₀ to maximum value of V₁. This can be done easily as electric potential can be rapidly increased by a corresponding increase to the duty cycle.

FIG. 20 shows a high voltage electric potential difference for single wire-accelerator electrode combination: desired curve (solid line) and real curve (dashed line) at high frequencies. During the second time interval (from t₁ to t₃) electric potential difference must monotonically decrease from V₁ to V₃. However, the wire-accelerator electrodes system has its own capacitance C and resistance R and, associated with them, characteristic time τ˜1/RC. Therefore, in the case wherein acoustic velocity has to rapidly decrease, i.e. when time interval (t₃−t₁) is less than or close to τ, an electric potential difference between wires and accelerator electrodes will not follow the desired curve even though duty cycle will decrease properly. Instead, the electric potential difference decay will be controlled by τ. In FIG. 20 this is shown by the dashed line. As a result, the acoustic velocity and acoustic signal will be distorted. Note that this effect occurs and is present at high frequencies. At low frequencies τ is less than (t₃−t₁) and system has sufficient time to decrease electric potential difference to “follow” the desired curve.

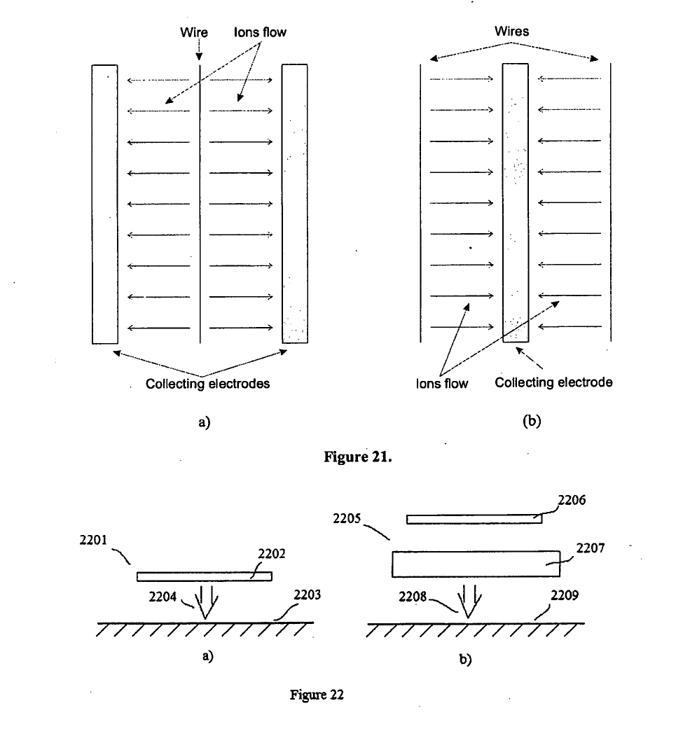

In order to eliminate shortcomings of single wire-accelerator electrode combination it is possible to use double wire-accelerator electrode combination examples of which are shown in FIG. 21. This configuration may consist of either one wire set and two accelerator electrode sets (FIG. 21 (a)) or two wire sets and one accelerator electrode set (FIG. 21 (b)).

Consider, for example, a system as shown in FIG. 21 (a). In the absence of an acoustic signal an electric potential difference between a central corona wire and both right and left accelerator electrodes is the same. Thus right and left portions of the system compensate or cancel each other to eliminate any net airflow. During a first time interval (from t₀ to t₁) an electric potential difference of the right portion increases while electric potential difference of the left portion decreases providing the desired air velocity. The decrease of electric potential difference of the left portion during the first time interval makes it possible to increase electric potential difference of the right portion less than it would be needed in case of constant electric potential difference and consequently to store less energy in the right portion of the system by time t₁. During the second time interval (from t₁ to t₃) the operation of the left and right portions is reversed: electric potential difference of the right portion decreases while it increases at the left portion. At high frequencies electric potential difference of the left portion increases such that it compensates for possible delay in electric potential decrease caused by the fact that time interval (t₃−t₁) is less than or close to characteristic time τ. Therefore, during operation of double wire-accelerator electrode combination shown in (a), electric potential difference increases at the right portion and decreases at the left portion when acoustic signal increases and electric potential difference decreases at the right portion and increases at the left portion when acoustic signal decreases. This can effectively eliminate acoustic signal distortion at high frequencies.

Using a similar concept as is described above in the double sided loudspeaker description it is possible to use a double sided loudspeaker not only to increase frequency response a the high end, but to create a “Push-Pull” effect for the loudspeaker, and potentially increase acoustic wave magnitude. The operation of mechanically driven speakers in a simplified sense is based on the high frequency extension and extraction of a membrane (e.g., a loudspeaker cone). This creates a push-pull phenomena that both creates a high pressure wave at the “push” of the membrane, as well as a low pressure wave, as the membrane pulls back creating a low pressure region. The EFA based loudspeaker design under normal operation includes only one of the two mechanisms i.e. the push mode. The EFA loudspeaker creates a push only mode loud speaker since the ions are accelerated, but not drawn back like that of the standard mechanical membrane. In one implementation of the EFA loudspeaker, a push-pull function is enabled by placing a corona wire between two independently driven collector electrodes. A bias is applied between the corona and collector electrodes, and an independent audio signal is driven on each collector electrode. The audio signals are inverted to each other, such that the “positive” swing on one side, would be matched by a simultaneous “negative” swing on the other side with equal magnitude and shape. This arrangement causes both a push and pull force to be exerted on the fluid. In one implementation, a predetermined time delay may be used between the two audio signals on the collector electrodes to account for any possible sound travel delay.

### Method of Compensating for Varying/Different Environmental Conditions.

The HVPS is responsible for providing a high voltage DC bias to the EFA array. This voltage should be roughly between the corona onset voltage and the voltage that would cause arcing between the EFA corona and accelerating electrodes. The magnitude of this voltage depends on many factors including, for example, the distance between the corona electrodes and accelerator electrodes, and altitude above sea level.

According to another aspect and embodiments of the present invention methods, algorithms and software may be employed to compensate for certain environmental features and conditions. One of these implementations is an algorithm that is based on an assumed or measured air composition (temp, pressure, humidity, etc.). The certain conditions or set of conditions are used in order to predict electrical breakdown voltage in the air. The algorithm is then used to scan a soundtrack or waveform to determine a “danger value” for all points or a subset of outlier points. Once the points and their corresponding values have been determined, the algorithm calculates and modifies some parts of the waveform to prevent sparking while maintaining optimum performance for the speakers at that time; or that is the operation voltage is dynamically adjusted to prevent the sparking event.

In one implementation a fluid environmental calibration device is imbedded in the loudspeaker. At predetermined points in time (such as on start up) the current-voltage characteristic and onset/breakdown voltage of the fluid environment are measured. The measured values are then used to calibrate the loudspeaker in order to determine optimum operation potentials.

### Ultrasonic Cleaning of the Surfaces.

This embodiment of the invention is directed to ultrasonic cleaning of surfaces, surface treatment, and High Intensity Focused Ultrasound (HIFU). An EFA acoustic actuator is used to produce ultrasonic acoustic pressure waves in a fluid that can then be used for surface cleaning or modification of a desired target. The surface may be made to be the accelerator electrode. This implementation is schematically shown in the FIG. 22 a). In another implantation the surface may be separate of the acoustic actuator. This implementation is schematically shown in the FIG. 22 b).

In FIG. 22(a) device 2201 for ultrasound surface cleaning is shown schematically. It consists of the conductive surface 2203 to be cleaned, the corona electrode 2202 and a HVPS (not shown). The HVPS that produces a DC bias voltage and ultrasound AC ripples is connected between corona electrode 2202 and conductive surface 2203. Ultrasound waves 2204 are produced between the corona electrode 2202 and the surface 2203 thus cleaning the latter.

In the FIG. 22(b) the device 2205 for ultrasound surface cleaning is shown schematically. It consists of the conductive surface 2209 to be cleaned, the corona electrode 2206, accelerating electrode 2207 and a HVPS (not shown). The HVPS that produces DC bias voltage ultrasound AC ripples is connected between corona electrode 2206 and accelerating electrode 2207. Ultrasound waves 2208 are produced between corona electrode 2206 and accelerating electrode 2207 penetrates through accelerating electrode 2207 and directed to surface 2209 thus cleaning the latter.

### Acoustic Weapon.

An acoustic weapon or defensive tool may be created using a phase array technique (geometrical or electrical) to create a single point, line, or multiple of points or lines with high intensity acoustic energy within a 3D space. In one implantation of an acoustic weapon or defensive tool, the high intensity point may be used to ward off animals, intruders, etc. by focusing the beam on or within them. In another implementation the same high intensity beam could be used as a manufacturing tool such as accelerated point curing in resins.

### Floating Loudspeaker.

The fluid within the chamber may be made of a fluid which is less dense than the environmental fluid surrounding it, allowing the EFA acoustic actuator to become buoyant in the environment and float. The environment fluid may be a liquid as well as air or any other fluid.

### Low Frequency and HF Parts are Each Connected to the Ground

See previous figures depicting grounding of elements (e.g., electrodes) that may easily be contacted by user to avoid a shock hazard from exposed elements of the EFA, e.g., electrodes.

### Spark Sensing.

The control system may further be configures to sense sparks, or arcs, or a pre-spark condition between the electrodes and promptly decreases at least a “low frequency” portion of the high voltage to a safe level. The arcing or sparking events are preferably sensed or measured between the electrodes, for instance, at the secondary winding of the step-up transformers, i.e. the corona current spikes or fluctuations.

### Expandable Corona Loudspeaker.

Some embodiments of a corona loudspeaker include a set of identical corona wires and accelerator electrodes. Both corona wires and accelerator electrodes are separated by some distance that is larger than a diameter of the corona wire and thickness of accelerator electrodes. Due to this fact, it is possible to make a corona loudspeaker expandable in a form that my be envisioned as similar to window blinds that are used to prevent room from sunlight. When an expandable corona speaker is not in use, it can be telescoped closed by moving all accelerator electrodes (and wires) to each other along a line that connects all accelerator electrodes (or wires). An expandable corona loudspeaker has many advantages. In a collapsed position, it occupies much less space than in the open position, an important feature for storage and transportation. An expandable corona loudspeaker can be placed over a window (as window blinds) where it can be used for active cancellation of noise coming from outside of the window as well as function as a speaker, air purification device, fan, or window blinds. When not in use, an expandable corona loudspeaker can be telescoped closed to avoid blocking any view from the window.

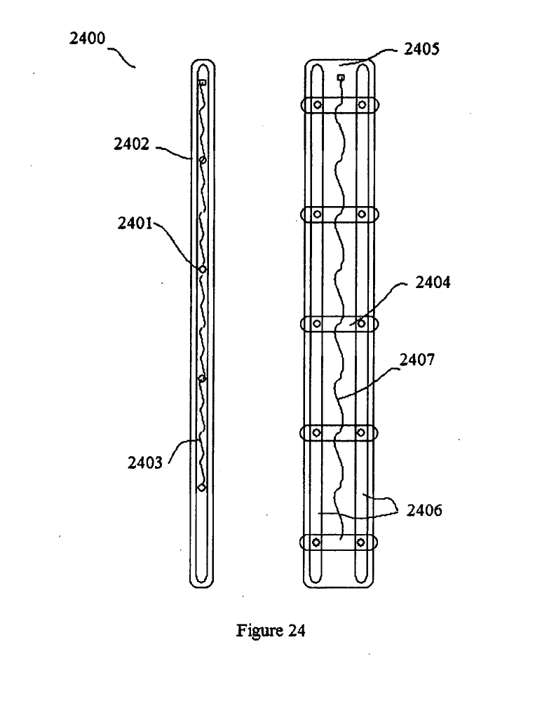

In FIG. 24 one possible implementations of the expandable EFA is shown schematically. Referring to FIG. 24, EFA 2400 of the proposed loudspeaker is shown in cross-section. The EFA consists of the wire-like corona electrodes 2401 (4 are shown as an example) and bar-like accelerating electrodes 2404 (5 are shown). Corona electrodes 2401 are located inside two slotted frames 2402 and are supported with springy stand-offs 2403. Accelerating electrodes 2404 are located on two the double-slotted frames 2405 with two slots 2406 in each frame and separated with springy stand-offs 2407. In normal operation all the electrodes are in the position shown in the FIG. 24. An EFA as described above may be located at any place, for instance on the wall or on the window. When not in use all the electrodes are pulled up in a manner similar to opening up a set of window blinds. Upon opening I=(i.e., collapsing the electrode array for storage), a HVPS may be deactivated. In the folded position, the EFA occupies less space and does not obstruct any view through the window.

### Tandemt Configuration of EFAs

Another implementation of the current invention stipulates several EFA located in series or tandem in order to increase sound intensity in the low frequency range. Sound intensity depends directly on the air pressure developed by EFA. It is known that N EFAs located in close proximity to each other develop up to N times greater air pressure than a single EFA.

Given the fact that wavelength at low frequency is rather large and much greater than the distance between the neighboring EFAs several identical EFAs may be installed one after another and be fed from the same HVPS.

### Phased Tandem Array of Multiple EFAs.

For higher frequencies the signal feeding different EFAs located in series should be delayed by the time air (or other fluid EFAs are located) travels in between of them. That is, tandem EFAs should be properly phased to additively accelerate the fluid (e.g., air) to increase net power output and improve performance.

### Locating and Positioning of Electrostatic Loudspeaker in Public Areas

Given extremely light weight and relative low cost of the proposed loudspeakers based on EFAs the area of use may be substantially expanded. For instance, in the public places, such as movie and similar theaters, there is a wide distribution of conditions present for various members of the audience. Some people may be seated near to audio components such as loudspeakers while the others are seated at some distance. It is often the case that nodes or “dead” spots form due to interference between one or more speakers.

Embodiments of the present invention include covering, for example, an entire or much of the ceiling of a room or theatre with a number flat EFAs. Such loudspeakers, being relatively light in weight, are easily secured to the ceiling without a danger of being dislodged and creating a hazard to the audience below. This enables uniform sound for all participants, rather than extreme volumes for people near the speakers, and low volume for people far from areas with speakers, and distorted and or low volume from people in-between speakers due to interference patterns.

### Focused Ultrasonic Acoustic Actuator Used as a High Intensity Focused Ultrasound (HIFU) Actuator(S) for Medical Procedures.

According to another embodiment of the invention, EFAs may be made in a shape that focuses (concentrates) sound energy into some small region or narrow area, even to the point. Such focusing may be performed mechanically (i.e., using appropriate EFA, enclosure and supplemental beam-forming structure geometry) and electrically (e.g., using a phased array of EFA elements).

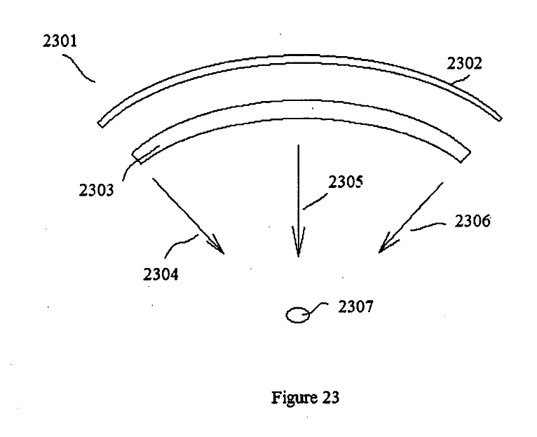

FIG. 23 depicts such an arrangement with loudspeaker EFA 2301 schematically shown in cross-section. EFA 2301 includes a globe-shaped corona electrode array 2302, containing multiple wire-like or needle-like corona electrodes with their ionizing edges located on the inwardly bending (concave) surface of the corona array. Accelerating electrode array 2303 may be made of rods, or grid, or in any other manner that is transparent to the sound and have electrical conductivity. HVPS (not shown) is connected to the electrodes' arrays 2302 and 2303. Object 2307 is some material to be destroyed or damaged by the powerful sound wave generated by the EFA 2301. Sound waves 2304, 2305 and 2306 are directed by the EFA geometry in such manner that it allows sound energy to be concentrated at and onto object 2307. With sufficient energy direct to and dissipated by the object it may be destroyed (e.g., kidney stone) or damaged (e.g., a tumor cell). Even though a high acoustic energy is generated at one point such as shown in 2307, the acoustic energy at all other points is significantly lower and therefore is not harmful to or destructive of the surrounding material or tissue.

Method of Transforming Acoustic Source Signal to Compensate for Distortions Created by Non Linear Pressure Vs. Voltage Relationship in an EFA Loudspeaker.

Pressure generated by the proposed EFA loudspeaker is proportional to the Coulombic force being applied to the fluid between the corona and accelerator electrodes. The total force is proportional to the ion current and the strength of the electric field. Because the ion current is dependent on the applied voltage, there exists a nonlinear change in pressure for a given change in voltage, which can lead to distortion of an acoustic signal as it is transuded into the fluid. This process can be represented symbolic as

S−>T[1]−>S′

Where S is the original audio signal, T[1] is the transfer function of the loudspeaker transduction system, and S′ is the resulting acoustic signal generated by the loudspeaker. If T[1] is not equal to 1 then S does not equal S′, meaning that S′ is a distorted signal of S. In order for S to be equal to S′ a when T[1] is not equal to 1, a second transfer function T[2] must be applied such that

S−>T[2]−>S″−>T[1]−>S′, where S=S′.

In order for S to equal S′ T[2] must be the inverse transform of T[1]. If an inverse transform of the loudspeaker transduction system is applied to the audio signal before it enters the loudspeaker, distortion from the loudspeaker system can be greatly reduced or eliminated.

It has been experimentally determined that airflow pressure, developed by an EFA, is directly proportional to the electrical power P, dissipated by the corona discharge. This electrical power is not always proportional to the voltage V between the corona and accelerator electrodes. For some electrodes configuration it may be proportional while for another it is described by the equation

P=KV(V−Vₒ)ⁿ,

where K is a coefficient, and Vₒ is corona discharge onset voltage, and n is a coefficient individual for the electrodes geometry and other conditions.

This is actually the nonlinear distortion T[1] of most common EFA geometry.

Therefore, T[2] should make the above or another appropriate formula into consideration in order to correct the distortion, caused by T[1]. An embodiment of the invention implement such a transform, applying it to the audio signal so as to compensate for distortion caused by this nonlinear pressure versus voltage relationship.

### Use of Corona Electrode Temperature (Field Enhanced Thermionic Emission) Modulation to Modulate Discharge Current and Thereby Create Acoustic Waves

The magnitude of the loudspeaker ion current is dependent on the temperature of the corona electrode material, this due to field enhanced thermionic emission of electrons from the corona electrode surface. The thermionic emission is dependent on temperature, and the work function of the electrode material. As the temperature is increased, the work function of the electrode material decreases, and thermionic emission increases, increasing the corona to accelerator electrode ion current and, therefore, the electrical power and acoustic pressure. By varying the surface temperature of the corona electrode the ionic current can be varied, thereby modulating the force on the fluid and creating acoustic waves in the fluid. The change in discharge current due to a change in wire surface temperature, may also be caused by non thermionic effects such as changing fluid medium properties due to the change in the medium temperature near the surface of the heated wire.

In one implementation, temperature modulation of the corona electrode can be obtained by passing an oscillating current through the corona electrode's conductive body. Heat is dissipated along the corona electrode due to joule heating of the material, raising the temperature of the electrode surface and thereby providing thermal modulation of the corona field and resultant variations in fluid flow.

### Use of Corona Electrode Temperature (Field Enhanced Thermionic Emission) to Adjust Loudspeaker Acoustic Intensity by Controlling Corona Electrode Temperature

Corona electrode temperature (field enhanced thermionic emission) may be used to control and adjust loudspeaker acoustic intensity (i.e., volume) by controlling corona electrode temperature. This allows for volume adjustment without needing to change high voltage bias or high voltage acoustic waveform amplification factor. Alternatively, both the voltage between the corona and collector and corona electrode temperature can be varied simultaneously.

As described above, temperature control of the corona electrode is used to modulate the ion current. By increasing the corona electrode surface temperature from T1 to T2, not only is the base ion current increased but, because the device is now operating higher on the current-voltage curve, changes in electric potential from the oscillating audio signal will create a larger change in current than at T1. The larger change in current results in a larger change in force being applied to the fluid, resulting in a larger acoustic wave magnitude.

In one implementation, corona electrode temperature could be used to adjust acoustic volume, without the need to change the high voltage bias or high voltage acoustic waveform amplification factor.

Hybrid, EFA and Electrostatic Loudspeaker Design.

A hybrid loudspeaker embodiment generates acoustic waves in a fluid using two “electrostatic” mechanisms. The first mechanism includes a method using alternating force on a fluid media by applying Coulombic force to ions in the fluid, and the second mechanism implementing a method wherein acoustic energy is applied to the fluid by applying modulated electrostatic force to a charged flexible membrane. The ions generated by the corona discharge may be used to charge a flexible membrane. The high voltage acoustic signal is then used to modulate the Coulombic force on the fluid and can be simultaneously used to modulate the force on the charged flexible membrane. This electrical membrane may be made of a conductive media and kept under constant or alternating voltage that is changing with accordance with input acoustic signal. The hybrid loudspeaker provides for improved loudspeaker performance in terms of overall sound volume at specific designed frequency bands.

### Polar Plot of Loudspeaker.

Polar plot or dependence of acoustic signal amplitude on its direction can be easily modified by the following ways or their combination:
a) Geometrical position of electrodes. For example, electrodes can be placed along a straight line or along a curve.
b) Phase control.

Although the invention has been described in connection with various illustrated embodiments, numerous modifications and adaptations may be made thereto without departing from the spirit and scope of the invention as set forth in the claims. Furthermore, it should be noted and understood that all publications, patents and patent applications mentioned in this specification are indicative of the level of skill in the art to which the invention pertains. All publications, patents and patent applications are herein incorporated by reference to the same extent as if each individual publication, patent or patent application was specifically and individually indicated to be incorporated by reference in its entirety.

While the foregoing has described what are considered to be the best mode and/or other preferred embodiments of the invention, it is understood that various modifications may be made therein and that the invention may be implemented in various forms and embodiments, and that it may be applied in numerous applications, only some of which have been described herein. It is intended by the following claims to claim any and all modifications and variations that fall within the true scope of the inventive concepts.

It should also be noted and understood that all publications, patents and patent applications mentioned in this specification are indicative of the level of skill in the art to which the invention pertains. All publications, patents and patent applications are herein incorporated by reference to the same extent as if each individual publication, patent or patent application was specifically and individually indicated to be incorporated by reference in its entirety.

1. A method of converting an audio signal into vibratory modulation of a fluid comprising the steps of:
converting a series of pulses representative of the audio signal into a plurality of signals having an intermediate peak-to-peak voltage;
summing said signals having said intermediate voltage to provide a driver signal having a high peak-to-peak voltage;
supplying said driver signal to an electrostatic fluid accelerator; and
generating a corona discharge inducing said vibratory modulation of said fluid.

2. The method according to claim 1 wherein said step of converting includes modulating a width of said pulses in response to an amplitude characteristic of said audio signal.

3. The method according to claim 1 wherein said step of converting includes modulating an amplitude of said pulses in response to an amplitude characteristic of said audio signal.

4. The method according to claim 1 wherein said step of converting includes generating a regular series of said pulses at a frequency of least 16 kHz.

5. The method according to claim 1 wherein said step of converting includes generating a regular series of said pulses at a frequency of least 40 kHz.

6. A method of converting an audio signal into vibratory modulation of a fluid comprising the steps of:
partitioning the audio signal into low-frequency and high-frequency constituent signals;
multiplying an input voltage to provide a first high voltage;
modulating said first high voltage with said low-frequency constituent signal to provide a low-frequency high voltage;
transforming said input voltage to provide a second high voltage;
modulating said second high voltage with said high-frequency constituent signal to provide a high-frequency high voltage;
combining said low-frequency and said high-frequency high voltage to provide a high voltage output;
supplying said high voltage output to an electrostatic fluid accelerator (EFA); and
modulating a fluid with said electrostatic fluid accelerator.

7. The method according to claim 6 further comprising a step of rapidly discharging electrical power stored in an external capacitance of said EFA array.

8. The method according to claim 6 further comprising a step of maintaining a difference between a voltage level of (i) said low-frequency voltage and (ii) a corona onset voltage of said EFA array close to a voltage level of said high-frequency voltage during each of a plurality of time periods whereby a maximum acceptable distortion of an audio output is not exceeded.

9. The method according to claim 6 further comprising a step of dynamically adjusting a voltage level of said low-frequency high voltage in response to a maximum peak level of the audio signal.

10. The method according to claim 6 wherein the comprises a plurality of contiguous segments, said method further comprising the step of:
dynamically adjusting, for each of said segments, a bias voltage level of said low-frequency high voltage in response to a maximum peak level of said audio signal occurring within each of said segments such that a minimum voltage level of said high voltage output is not less than a corona onset voltage of said EFA array.
